(19) United States
(12) Patent Application Publication
(10) Pub. No.: US 2026/0231860 A1
(43) Pub. Date: Aug. 13, 2026

(54) LAWN MOWER

(71) Applicant: Positec Power Tools (Suzhou) Co., Ltd, Suzhou (CN)

(72) Inventors: Changhua LIU, Suzhou (CN); Shiping JIAO, Suzhou (CN); Biao WANG, Suzhou (CN); Xinghong LI, Suzhou (CN); Gang XU, Suzhou (CN)

(21) Appl. No.: 19/631,647

(22) Filed: Mar. 27, 2026

Related U.S. Application Data
(63) Continuation of application No. PCT/CN2024/122498, filed on Sep. 9, 2024.

(30) Foreign Application Priority Data
Sep. 28, 2023 (CN) 202322663175.8

(51) Int. Cl. A01D 34/73; A01D 34/76; A01D 101/00

(52) U.S. Cl. CPC A01D 34/73; A01D 34/76; A01D 2101/00

(57) ABSTRACT

A lawn mower, including: a body; a movement module configured to drive the lawn mower to move; a cutting disc having at least one blade, the cutting disc rotating under driving of a cutting motor to drive the blade to rotate, the blade including a blade body for connecting with the cutting disc and a cutting portion connected with the blade body for performing lawn mowing work; wherein the movement module is configured to drive the lawn mower to move at a travel speed greater than or equal to 1 m/s, the cutting motor is configured to drive the blade to rotate to achieve a linear velocity of the blade greater than or equal to 30 m/s and less than or equal to 70 m/s, and the blade body has a hardness value in a hardness value range of 5-45 HRC.

### CROSS-REFERENCE TO RELATED APPLICATIONS

This application is a Continuation Application of PCT Application No. PCT/CN2024/122498, filed on Sep. 29, 2024, which claims priority to Chinese Patent Application No. 202322663175.8, filed on Sep. 28, 2023, all of which are hereby incorporated by reference in their entirety for all purposes as if fully set forth herein.

### TECHNICAL FIELD

The present disclosure relates to the field of garden equipment tool technology, and particularly relates to a lawn mower.

### BACKGROUND

With an improvement of a technological level and a development of society, more and more power tools have entered people's lives, replacing people to complete many tasks, thereby reducing people's burden and bringing great convenience to people. The power tool usually includes a blade mounted on a drive shaft, and the blade is driven to rotate by the drive shaft to perform a cutting work.

However, currently, the power tool such as a lawn mower has a phenomenon of blade breakage when the blade hits a hard object such as a stone.

### SUMMARY

In view of this, a purpose of the present disclosure is to provide a lawn mower, one purpose of which is to improve a problem of lawn mower blade breakage.

Based on the above purpose, the present disclosure provides a lawn mower, comprising: a body; a movement module configured to drive the lawn mower to move; a cutting disc comprising at least one blade, the cutting disc rotating under driving of a cutting motor to drive the blade to rotate, the blade comprising: a blade body for connecting with the cutting disc, and a cutting portion connected with the blade body for performing mowing operations; a travel speed is greater than or equal to 1 m/s, and a linear velocity of the blade is greater than or equal to 30 m/s and less than or equal to 70 m/s, a hardness value range of the blade body is 5-45 HRC.

In an optional implementation, the travel speed is greater than or equal to 1.5 m/s and the linear velocity of the blade is greater than or equal to 30 m/s and less than or equal to 70 m/s, the hardness value range of the blade body is 5-45 HRC.

In an optional implementation, the travel speed is greater than or equal to 2 m/s and the linear velocity of the blade is greater than or equal to 30 m/s and less than or equal to 70 m/s, the hardness value range of the blade body is 5-45 HRC.

In an optional implementation, the travel speed is greater than or equal to 1 m/s and the linear velocity of the blade is greater than or equal to 40 m/s and less than or equal to 60 m/s, the hardness value range of the blade body is 10-30 HRC.

In an optional implementation, the travel speed is greater than or equal to 1.5 m/s and the linear velocity of the blade is greater than or equal to 40 m/s and less than or equal to 60 m/s, the hardness value range of the blade body is 10-30 HRC.

In an optional implementation, the travel speed is greater than or equal to 2 m/s and the linear velocity of the blade is greater than or equal to 40 m/s and less than or equal to 60 m/s, the hardness value range of the blade body is 10-30 HRC.

In an optional implementation, the travel speed is greater than or equal to 1 m/s and the linear velocity of the blade is greater than or equal to 40 m/s and less than or equal to 60 m/s, the hardness value range of the blade body is 10-25 HRC.

In an optional implementation, the travel speed is greater than or equal to 1.5 m/s and the linear velocity of the blade is greater than or equal to 40 m/s and less than or equal to 60 m/s, the hardness value range of the blade body is 10-25 HRC.

In an optional implementation, the travel speed is greater than or equal to 2 m/s and the linear velocity of the blade is greater than or equal to 40 m/s and less than or equal to 60 m/s, the hardness value range of the blade body is 10-25 HRC.

In an optional implementation, the hardness of the cutting portion is greater than or equal to 50 HRC.

In an optional implementation, the hardness of the cutting portion is greater than or equal to 60 HRC.

In an optional implementation, the hardness of the cutting portion is less than or equal to 80 HRC.

In an optional implementation, the hardness range of the cutting portion is 60-70 HRC.

In an optional implementation, a length of the blade extending from the cutting disc is greater than or equal to 5 mm.

In an optional implementation, the length of the blade extending from the cutting disc is 5-70 mm.

In an optional implementation, the length of the blade extending from the cutting disc is 30-70 mm.

In an optional implementation, a thickness of the blade is less than or equal to 5 mm.

In an optional implementation, the thickness of the blade is 0.5-2 mm.

In an optional implementation, a width of the cutting portion is 0.1-5 mm.

In an optional implementation, the number of the at least one blade is 3 to 6.

In an optional implementation, one end of the blade body is provided with a rotating shaft mounting hole for mounting a rotating shaft, and the hardness of the rotating shaft is greater than that of the blade body.

In an optional implementation, also comprised is a dulling zone for gripping the blade body, and the dulling zone is disposed on the blade body at one end close to the rotating shaft mounting hole.

From the above description, it can be seen that the lawn mower provided by the present disclosure reduces a risk of blade breakage by reducing the hardness of the blade body, or simultaneously improving the hardness of the blade body and the hardness of the cutting portion, when the travel speed increases and the linear velocity improves, under a premise that the blade thickness cannot be too thick and the length of the blade extending from the cutting disc cannot be too short.

### BRIEF DESCRIPTION OF THE DRAWINGS

In order to more clearly illustrate technical solutions in the present disclosure or a related technology, the following will briefly introduce drawings needed for use in a description of embodiments or the related technology. The drawings in the following description are only embodiments of the present disclosure. For a person of ordinary skill in the art, other drawings can also be obtained based on these drawings without a creative labor.

FIG. 1 is a front view of the blade in some embodiments of the present disclosure;

FIG. 2 is a cross-sectional structural schematic diagram of part A-A in FIG. 1;

FIG. 3 is an enlarged structural schematic diagram of part B in FIG. 2;

FIG. 4 is a structural schematic diagram of different hardness regions of the blade body and the cutting portion in some embodiments of the present disclosure;

FIG. 5 is a structural schematic diagram of the lawn mower in some embodiments of the present disclosure;

FIG. 6 is a schematic diagram of the blade thickness M in some embodiments of the present disclosure;

FIG. 7 is a structural schematic diagram of the cutting disc in some embodiments of the present disclosure; wherein 3 blades are schematically shown.

### DETAILED DESCRIPTION

To make the objectives, technical solutions, and advantages of the present disclosure clearer and more understandable, the present disclosure will be further described in detail below in conjunction with specific embodiments and with reference to the drawings.

It should be noted that, unless otherwise defined, a technical term or a scientific term used in an embodiment of the present disclosure should have a usual meaning understood by a person with a general skill in the field to which the present disclosure belongs. A “first”, a “second” and a similar word used in an embodiment of the present disclosure do not indicate any order, quantity or importance, but are only used to distinguish different components. An “including” or a “comprising” and a similar word mean that an element or an object appearing before the word covers an element or an object listed after the word and an equivalent thereof, without excluding another element or object. A “connected” or a “connection” and a similar word are not limited to a physical or a mechanical connection, but may include an electrical connection, whether direct or indirect. An “upper”, a “lower”, a “left”, a “right”, etc. are only used to indicate a relative positional relationship, and when an absolute position of a described object changes, the relative positional relationship may also change accordingly.

The following first provides a brief overview of the lawn mower:

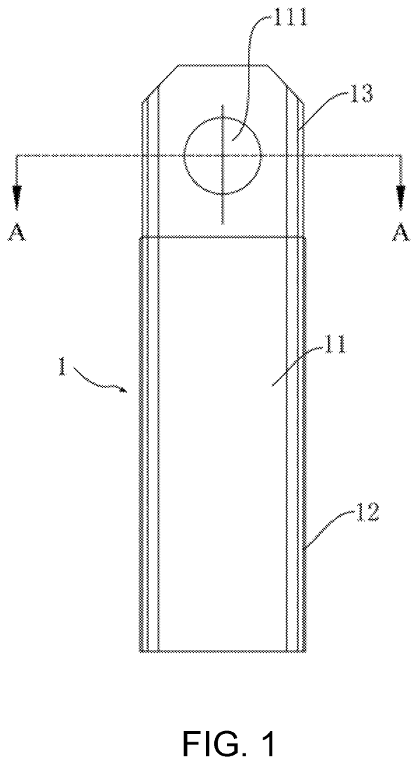

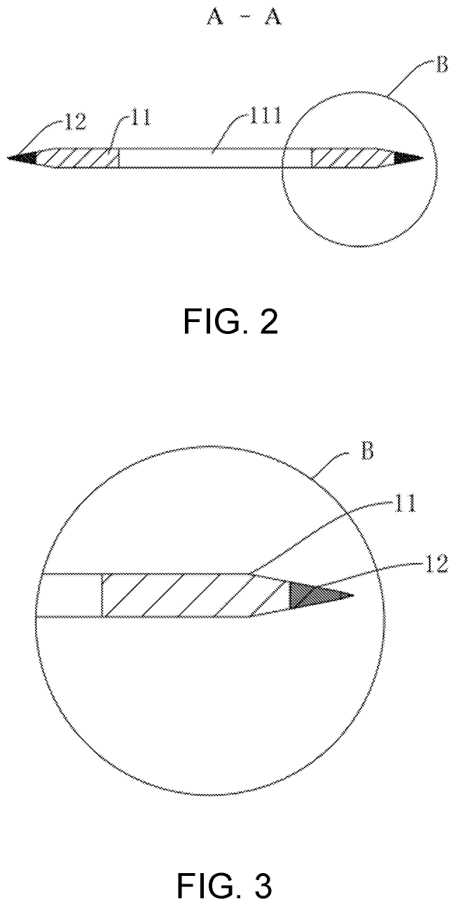

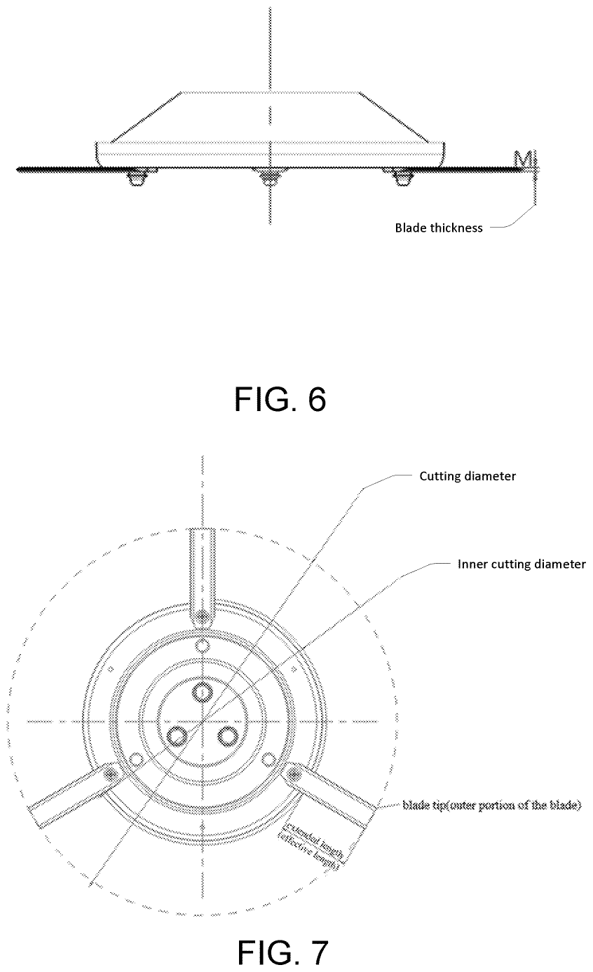

Referring to FIG. 1 to FIG. 7, the lawn mower comprises: a body, a movement module, a cutting module, and a control module; the movement module and the cutting module are respectively electrically connected to the control module. Wherein, the movement module is mounted on the body, and configured to drive the lawn mower to travel, for example, to drive an automatic lawn mower to travel within a working area; specifically, the movement module includes a travel wheel and a drive motor for driving the travel wheel to travel, and an output end of the drive motor is connected to the travel wheel. The cutting module is mounted on the body, and configured to perform a lawn mowing task in the working area, for example, to cut grass in a lawn to be cut. Specifically, the cutting module includes a cutting disc and a cutting motor for driving the cutting disc to rotate, the cutting disc is provided with at least one blade, the cutting disc rotates under driving of the cutting motor, thereby driving the blade thereon to cut the grass. The control module is mounted inside the body, and used to control the movement module to drive the automatic lawn mower to move, and control the cutting module to perform a cutting task.

The power tool such as the lawn mower has a phenomenon of blade breakage when the blade hits a hard object such as a stone.

In order to reduce a risk of blade breakage, in a first aspect, the blade thickness may be increased, but considering that a manufacturing difficulty is high due to an excessively thick blade, the blade thickness should not be too thick.

It should be noted that the thicker the blade is, the higher the blade body hardness can be, but existing process cannot achieve an excessively thick blade.

In order to reduce the risk of blade breakage, in a second aspect, the effective length of the blade may be shortened, but considering that an excessively short effective length of the blade will fail to cut grass, the effective length of the blade should not be too short.

That is to say, the shorter the length of the blade extending from the cutting disc is, the less likely the blade is to break, but when the length of the blade extending from the cutting disc is too short, grass cannot be cut, and the cutting quality decreases.

With increasingly higher requirements from consumers for the lawn mower use, such as a need for higher cutting efficiency, and the cutting efficiency being related to the travel speed of the lawn mower, in other words, the travel speed of the lawn mower affects the cutting efficiency, therefore, in order to improve the cutting efficiency. In some embodiments, the cutting efficiency may be improved by increasing the travel speed, for example, increasing the travel speed to obtain higher cutting efficiency. In some embodiments, the travel speed is greater than or equal to 0.8 m/s; in some embodiments, the travel speed is greater than or equal to 1 m/s; further, the travel speed is greater than or equal to 1.5 m/s; furthermore, the travel speed is greater than or equal to 2 m/s.

Generally speaking, the faster the travel speed is, the faster the linear velocity of the blade should be; a reason is that when the travel speed becomes faster, if the linear velocity before the travel speed becomes faster is used, the original cutting quality (or cutting effect) cannot be achieved for the same lawn. Therefore, in order to improve the cutting quality, the linear velocity needs to be adaptively increased. That is to say, when the travel speed becomes faster, the linear velocity needs to be adaptively increased to meet the cutting quality requirement. That is, the linear velocity is related to the travel speed. In some embodiments, the linear velocity may be increased to adapt to a faster travel speed, for example, when the travel speed is greater than or equal to 0.8 m/s, especially when the travel speed is greater than or equal to 1 m/s, the linear velocity of the blade is greater than or equal to 30 m/s. For example, when the travel speed is greater than or equal to 1 m/s, the linear velocity of the blade is greater than or equal to 34 m/s. For another example, when the travel speed is greater than or equal to 1.5 m/s, the linear velocity of the blade is greater than or equal to 40 m/s.

Considering that an excessively large linear velocity will increase the risk that the blade easily hits a hard object and breaks, therefore in some embodiments, the linear velocity of the blade is less than or equal to 70 m/s. Further, the linear velocity of the blade is less than or equal to 60 m/s. Furthermore, the linear velocity is less than or equal to 50 m/s. Therefore, in some embodiments, when the travel speed is greater than or equal to 0.8 m/s, the linear velocity of the blade is greater than or equal to 30 m/s, and less than or equal to 70 m/s; for example, when the travel speed is equal to 1 m/s, a range of the linear velocity of the blade is 34-35 m/s.

In some embodiments, when the travel speed is greater than or equal to 1 m/s, the linear velocity of the blade is greater than or equal to 30 m/s, for example, when the travel speed is equal to 1 m/s, the range of the linear velocity of the blade is 34-35 m/s.

In some embodiments, when the travel speed is greater than or equal to 1 m/s, the linear velocity of the blade is greater than or equal to 34 m/s, and less than or equal to 60 m/s. For example, when the travel speed is equal to 1 m/s, the linear velocity of the blade is 38 m/s.

In some embodiments, when the travel speed is greater than or equal to 1.5 m/s, the linear velocity of the blade is greater than or equal to 40 m/s, and less than or equal to 60 m/s. For example, when the travel speed is 2 m/s, the linear velocity of the blade is 44 m/s-45 m/s; for another example, when the travel speed is 2 m/s, the linear velocity of the blade is 49 m/s-50 m/s.

In some embodiments, when the travel speed is greater than or equal to 2 m/s, the linear velocity of the blade is greater than or equal to 40 m/s, and less than or equal to 50 m/s. For example, when the travel speed is 2 m/s, the linear velocity of the blade is 44 m/s-45 m/s; for another example, when the travel speed is 2 m/s, the linear velocity of the blade is 49 m/s-50 m/s.

Considering that when the linear velocity increases, the risk of blade breakage increases, therefore, in order to reduce the risk of blade breakage, the hardness of the blade may be improved. That is, the problem of blade breakage caused by an increased linear velocity is addressed by improving the hardness of the blade. The improvement is particularly applicable to the lawn mower that reduces the risk of blade breakage by improving the blade, for example the hardness of the blade body, based on the problems existing in the first aspect and the second aspect.

In some embodiments, when the linear velocity of the blade is greater than or equal to a set value, wherein the set value is 30 m/s; on one hand, the blade can be made softer by improving the hardness of the blade body, for example, when the linear velocity of the blade is greater than or equal to 30 m/s, the hardness of the blade body is controlled to be below 45 HRC; that is, the hardness of the blade body is less than or equal to 45 HRC. Further, when the linear velocity of the blade is greater than or equal to 30 m/s, the hardness of the blade body is less than or equal to 30 HRC. Further, when the linear velocity of the blade is greater than or equal to 30 m/s, the hardness of the blade body is less than or equal to 25 HRC.

Considering that the blade body is prone to bending when the hardness of the blade body is too low, therefore, the hardness of the blade body should not be too low. In some embodiments, when the linear velocity of the blade is greater than or equal to 30 m/s, the hardness of the blade body is greater than or equal to 5 HRC. Further, when the linear velocity of the blade is greater than or equal to 30 m/s, the hardness of the blade body is greater than or equal to 10 HRC.

From the above, it can be known that, in some embodiments, when the linear velocity of the blade is greater than or equal to 30 m/s, the hardness of the blade body is greater than or equal to 5 HRC, and less than or equal to 45 HRC.

In some embodiments, when the linear velocity of the blade is greater than or equal to 30 m/s, the hardness of the blade body is greater than or equal to 10 HRC, and less than or equal to 30 HRC. For example, when the linear velocity of the blade is greater than or equal to 40 m/s, the hardness range of the blade body is 10-30 HRC.

In some embodiments, when the linear velocity of the blade is greater than or equal to 30 m/s, the hardness of the blade body is greater than or equal to 10 HRC, and less than or equal to 25 HRC. For example, when the linear velocity of the blade is greater than or equal to 40 m/s, the hardness range of the blade body is 10-25 HRC.

Considering that an excessively large linear velocity will increase the risk that the blade easily hits a hard object and breaks, therefore in some embodiments, the linear velocity of the blade is less than or equal to 70 m/s. Further, the linear velocity of the blade is less than or equal to 60 m/s. Furthermore, the linear velocity is less than or equal to 50 m/s.

Therefore, in some embodiments, when the linear velocity of the blade is greater than or equal to 30 m/s, and less than or equal to 70 m/s, the hardness of the blade body is greater than or equal to 5 HRC, and less than or equal to 45 HRC. For example, when the linear velocity of the blade is 34-35 m/s, the hardness of the blade body is 40 HRC.

In some embodiments, when the linear velocity of the blade is greater than or equal to 40 m/s, and less than or equal to 60 m/s, the hardness of the blade body is greater than or equal to 10 HRC, and less than or equal to 30 HRC. For example, when the linear velocity of the blade is equal to 44 m/s-45 m/s, the hardness of the blade body is 20-30 HRC. For another example, when the linear velocity of the blade is equal to 49 m/s-50 m/s, the hardness of the blade body is 10-20 HRC.

In some embodiments, when the linear velocity of the blade is greater than or equal to 40 m/s, and less than or equal to 60 m/s, the hardness of the blade body is greater than or equal to 10 HRC, and less than or equal to 25 HRC. For example, when the linear velocity of the blade is equal to 49 m/s-50 m/s, the hardness of the blade body is 10-20 HRC.

In some embodiments, when the linear velocity of the blade is greater than or equal to 40 m/s, and less than or equal to 50 m/s, the hardness of the blade body is greater than or equal to 10 HRC, and less than or equal to 25 HRC. For example, when the linear velocity of the blade is equal to 49 m/s-50 m/s, the hardness of the blade body is 10-20 HRC.

Considering that the cutting portion is not wear-resistant if the hardness of the cutting portion is too low, and the cutting portion is limited by a process material if the hardness of the cutting portion is too high, in other words, the higher the hardness of the cutting portion, the more wear-resistant the cutting portion is, but current process cannot achieve a very high hardness; in summary, in order to make the cutting portion meet the wear-resistance requirement, therefore, in some embodiments, the hardness of the cutting portion may be improved to meet the wear-resistance requirement. For example, when the linear velocity of the blade is greater than or equal to 30 m/s, the hardness of the cutting portion is greater than or equal to 50 HRC; further, when the linear velocity of the blade is greater than or equal to 30 m/s, the hardness of the cutting portion is greater than or equal to 55 HRC; for example, when the linear velocity of the blade is greater than or equal to 34 m/s, the hardness of the cutting portion is greater than or equal to 55 HRC. Furthermore, when the linear velocity of the blade is greater than or equal to 30 m/s, the hardness of the cutting portion is greater than or equal to 60 HRC. For example, when the linear velocity of the blade is greater than or equal to 40 m/s, the hardness of the cutting portion is greater than or equal to 60 HRC.

Considering a current process limitation, the hardness of the cutting portion cannot be made very high, therefore, in some embodiments, when the linear velocity of the blade is greater than or equal to 30 m/s, the hardness of the cutting portion is less than or equal to 80 HRC. Further, when the linear velocity of the blade is greater than or equal to 30 m/s, the hardness of the cutting portion is less than or equal to 75 HRC. For example, when the linear velocity of the blade is greater than or equal to 34 m/s, the hardness of the cutting portion is less than or equal to 75 HRC. Furthermore, when the linear velocity of the blade is greater than or equal to 30 m/s, the hardness of the cutting portion is less than or equal to 70 HRC. For example, when the linear velocity of the blade is greater than or equal to 40 m/s, the hardness of the cutting portion is less than or equal to 70 HRC.

From the above, it can be known that, in some embodiments, when the linear velocity of the blade is greater than or equal to 30 m/s, the hardness of the cutting portion is greater than or equal to 50 HRC, and less than or equal to 80 HRC.

In some embodiments, when the linear velocity of the blade is greater than or equal to 30 m/s, the hardness of the cutting portion is greater than or equal to 55 HRC, and less than or equal to 75 HRC.

In some embodiments, when the linear velocity of the blade is greater than or equal to 30 m/s, the hardness of the cutting portion is greater than or equal to 60 HRC, and less than or equal to 70 HRC.

Considering that an excessively large linear velocity will increase the risk that the blade easily hits a hard object and breaks, therefore in some embodiments, the linear velocity of the blade is less than or equal to 70 m/s. Further, the linear velocity of the blade is less than or equal to 60 m/s. Furthermore, the linear velocity is less than or equal to 50 m/s.

In some embodiments, when the linear velocity of the blade is greater than or equal to 30 m/s, and less than or equal to 70 m/s, the hardness of the cutting portion is greater than or equal to 50 HRC.

In some embodiments, when the linear velocity of the blade is greater than or equal to 40 m/s, and less than or equal to 60 m/s, the hardness of the cutting portion is greater than or equal to 55 HRC.

In some embodiments, when the linear velocity of the blade is greater than or equal to 40 m/s, and less than or equal to 50 m/s, the hardness of the cutting portion is greater than or equal to 60 HRC.

In summary, in some embodiments, when the linear velocity of the blade is greater than or equal to 30 m/s, and less than or equal to 70 m/s, the hardness of the cutting portion is greater than or equal to 50 HRC, and less than or equal to 80 HRC. For example, when the linear velocity of the blade is 34-35 m/s, the hardness of the blade body is 60-70 HRC.

In some embodiments, when the linear velocity of the blade is greater than or equal to 40 m/s, and less than or equal to 60 m/s, the hardness of the cutting portion is greater than or equal to 55 HRC, and less than or equal to 75 HRC. For example, when the linear velocity of the blade is equal to 44 m/s-45 m/s, the hardness of the cutting portion is 60-70 HRC. For another example, when the linear velocity of the blade is equal to 49 m/s-50 m/s, the hardness of the cutting portion is 60-70 HRC.

In some embodiments, when the linear velocity of the blade is greater than or equal to 40 m/s, and less than or equal to 50 m/s, the hardness of the cutting portion is greater than or equal to 60 HRC, and less than or equal to 70 HRC. For example, when the linear velocity of the blade is equal to 44 m/s-45 m/s, the hardness of the cutting portion is 60-70 HRC. For another example, when the linear velocity of the blade is equal to 49 m/s-50 m/s, the hardness of the cutting portion is 60-70 HRC.

In some embodiments, in order to meet the toughness requirement of the blade body and the wear-resistance requirement of the cutting portion, the hardness of the blade body and the hardness of the cutting portion may be improved; for example, when the linear velocity of the blade is greater than or equal to 30 m/s, the hardness of the blade body is 5-45 HRC, and the hardness of the cutting portion is 50 HRC or above. For another example, when the linear velocity of the blade is greater than or equal to 30 m/s, the hardness of the blade body is 10-30 HRC, and the hardness of the cutting portion is 55 HRC or above. For another example, when the linear velocity of the blade is greater than or equal to 30 m/s, the hardness of the blade body is 10-25 HRC, and the hardness of the cutting portion is 60 HRC or above.

Considering a current process limitation, the hardness of the cutting portion cannot be made very high, therefore, in some embodiments, for example, when the linear velocity of the blade is greater than or equal to 30 m/s, the hardness of the blade body is 5-45 HRC, and the hardness of the cutting portion is 50-80 HRC. For another example, when the linear velocity of the blade is greater than or equal to 30 m/s, the hardness of the blade body is 10-30 HRC, and the hardness of the cutting portion is 55-75 HRC. For another example, when the linear velocity of the blade is greater than or equal to 30 m/s, the hardness of the blade body is 10-25 HRC, and the hardness of the cutting portion is 60-70 HRC.

Considering that an excessively large linear velocity will increase the risk that the blade easily hits a hard object and breaks, therefore, in some embodiments, for example, when the linear velocity of the blade is greater than or equal to 30 m/s, and less than or equal to 70 m/s, the hardness of the blade body is 5-45 HRC, and the hardness of the cutting portion is 50-80 HRC. When the linear velocity of the blade is greater than or equal to 30 m/s, and less than or equal to 70 m/s, the hardness of the blade body is 10-30 HRC, and the hardness of the cutting portion is 55-75 HRC. For another example, when the linear velocity of the blade is greater than or equal to 30 m/s, and less than or equal to 70 m/s, the hardness of the blade body is 10-25 HRC, and the hardness of the cutting portion is 60-70 HRC.

In summary, in some embodiments, when the linear velocity of the blade is greater than or equal to 30 m/s, and less than or equal to 70 m/s, the hardness of the blade body is greater than or equal to 5 HRC, and less than or equal to 45 HRC; the hardness of the cutting portion is greater than or equal to 50 HRC, and less than or equal to 80 HRC. For example, when the linear velocity of the blade is 34-35 m/s, the hardness of the blade body is 40 HRC, and the hardness of the cutting portion is 60-70 HRC.

In some embodiments, when the linear velocity of the blade is greater than or equal to 40 m/s, and less than or equal to 60 m/s, the hardness of the blade body is greater than or equal to 10 HRC, and less than or equal to 30 HRC; the hardness of the cutting portion is greater than or equal to 55 HRC, and less than or equal to 75 HRC. For example, when the linear velocity of the blade is equal to 44 m/s-45 m/s, the hardness of the blade body is 20-30 HRC; the hardness of the cutting portion is 60-70 HRC. For another example, when the linear velocity of the blade is equal to 49 m/s-50 m/s, the hardness of the cutting portion is 60-70 HRC.

In some embodiments, when the linear velocity of the blade is greater than or equal to 40 m/s, and less than or equal to 50 m/s, the hardness of the blade body is greater than or equal to 10 HRC, and less than or equal to 25 HRC; the hardness of the cutting portion is greater than or equal to 60 HRC, and less than or equal to 70 HRC. For example, when the linear velocity of the blade is equal to 49 m/s-50 m/s, the hardness of the blade body is 10-20 HRC; the hardness of the cutting portion is 60-70 HRC.

Considering that the lawn mower may adopt a multi-layer blade, which is usually arranged in a staggered manner, the blade in a different layer has a different cutting radius (or a cutting diameter), and the linear velocity is related to the cutting radius (or the cutting diameter) of the blade, generally speaking, the multi-layer blade is usually arranged in a stepped manner, the more blade layers there are, the greater the linear velocity of an upper layer blade is, that is to say, the linear velocity of the blade is related to the number of layers of the blade, and the linear velocity of the blade affects the cutting quality, therefore, the lawn mower using the multi-layer blade has a higher requirement for the cutting efficiency and the cutting quality, in order to adapt to the cutting requirement of the multi-layer blade, in some embodiments, the (minimum) linear velocity of the multi-layer blade is greater than a linear velocity of a single-layer blade, especially at the same travel speed, the linear velocity when the lawn mower uses the multi-layer blade is greater than the linear velocity when the lawn mower uses the single-layer blade.

Therefore, in some embodiments, when the travel speed is 2 m/s, for the lawn mower with a single-layer blade, the linear velocity of the blade is 44 m/s-45 m/s; when the travel speed is 2 m/s, for the lawn mower with the multi-layer blade, the linear velocity of the blade is 49 m/s-50 m/s.

It can be understood that, as shown in FIG. 5, for the multi-layer blade, along the height direction of the lawn mower, from top to bottom, the diameter of the cutting trajectory the a blade gradually decreases, therefore, the linear velocity of the blade gradually decreases, in other words, the diameter of the cutting trajectory of the blade located above is greater than the diameter of the cutting trajectory of the blade located below, therefore, the linear velocity of the blade located above is greater than the linear velocity of the blade located below, wherein, for the multi-layer blade, the linear velocity of the blade refers to the linear velocity of the bottommost layer blade or the minimum linear velocity.

Considering that the multi-layer blade may be arranged in a staggered manner, therefore each layer has a different linear velocity, in some embodiments, in order to reduce the risk of blade breakage, the hardness of a blade (body) with a high linear velocity is less than a hardness of a blade (body) with a low linear velocity, for example, for the multi-layer blade distributed in a stepped manner in FIG. 5, from bottom to top, the linear velocity of the blade increases sequentially, therefore from bottom to top, the hardness of the blade body decreases sequentially, to reduce the risk of blade breakage.

Considering that the blade is disposed on the cutting disc, the length of the blade extending from the cutting disc (referred to as the effective length of the blade) affects the lawn mowing quality, in other words, in order to improve the lawn mowing quality, the effective length of the blade may be increased, given that when the effective length of the blade is too short, grass cannot be cut, the lawn mowing quality decreases or the lawn mowing effect is poor. Therefore, the effective length of the blade cannot be too short, for example, in some embodiments, the effective length of the blade is greater than or equal to 5 mm. Considering that for some large-volume lawn mowers, such as a commercial lawn mower, the cutting efficiency and the cutting quality requirement are high, therefore the effective length requirement of the blade is higher, therefore, in some embodiments, the effective length of the blade is greater than or equal to 30 mm.

It can be understood that due to the fact that a large-volume lawn mower, such as the commercial lawn mower, has a high requirement for cutting efficiency, therefore the travel speed of the commercial lawn mower is also relatively higher (compared to a small lawn mower, such as a smart lawn mower).

Considering that the blade is prone to breakage when the length of the blade extending from the cutting disc (referred to as the effective length of the blade) is too long, therefore, the effective length of the blade cannot be too long, for example, in some embodiments, the effective length of the blade is less than or equal to 70 mm.

In summary, in some embodiments, the effective length of the blade is greater than or equal to 5 mm, and less than or equal to 70 mm. Further, the effective length of the blade is greater than or equal to 30 mm, and less than or equal to 70 mm.

And in order to adapt to an increased risk of blade breakage that a longer blade (for the lawn mower with a very high requirement for a cutting efficiency and a cutting quality) may bring, therefore, in some embodiments, the body hardness of the blade should be softer. For example, the blade body hardness when the effective length of the blade is equal to 30 mm is less than the blade body hardness when the effective length of the blade is equal to 5 mm. In other words, the longer the effective length of the blade, the lower the hardness of the blade body.

For example, in some embodiments, when the effective length of the blade is greater than or equal to 5 mm, and less than or equal to 70 mm, the hardness of the blade body is greater than or equal to 10 HRC, and less than or equal to 30 HRC. And when the effective length of the blade is greater than or equal to 30 mm, and less than or equal to 70 mm, the hardness of the blade body is greater than or equal to 10 HRC, and less than or equal to 25 HRC.

Further considering the lawn mower with a higher cutting quality requirement, the linear velocity of the blade is relatively higher and/or the effective length of the blade is relatively longer.

Therefore, in some embodiments, when the linear velocity of the blade is greater than or equal to 40 m/s, and less than or equal to 60 m/s, and the effective length of the blade is greater than or equal to 5 mm, and less than or equal to 70 mm, the hardness of the blade body is greater than or equal to 10 HRC, and less than or equal to 30 HRC; and when the linear velocity of the blade is greater than or equal to 40 m/s, and less than or equal to 60 m/s, and the effective length of the blade is greater than or equal to 30 mm, and less than or equal to 70 mm, the hardness of the blade body is greater than or equal to 10 HRC, and less than or equal to 25 HRC;

For example, when the linear velocity of the blade is equal to 44 m/s-45 m/s, the effective length of the blade is equal to 15 mm, and the hardness of the blade body is 20-30 HRC. And when the linear velocity of the blade is equal to 49 m/s-50 m/s, the effective length of the blade is 30 mm or above, and the hardness of the blade body is 10-20 HRC. For example, in some embodiments, when the linear velocity of the blade is equal to 49 m/s-50 m/s, the effective length of the blade is 50 mm-60 mm, and the hardness of the blade body is 10-20 HRC. It should be pointed out that the effective length of the blade being 50 mm-60 mm is to cover the multi-layer blade, for example, the effective length of the bottommost layer blade is 50 mm, and the effective length of the topmost layer blade is 60 mm.

It should be pointed out that, in order to improve the lawn mowing quality or the lawn mowing effect, a multi-blade may be adopted, that is, an improvement of the lawn mowing quality is achieved through multiple cutting. Therefore, in some embodiments, for the same blade effective length, the cutting quality of the lawn mower using the multi-blade is greater than the cutting quality of the lawn mower using a single blade. For example, the effective length of the blade is 5-6 mm, further, the number of blades is selected as 5-6 pieces, to improve the cutting quality. For another example, the effective length of the blade is 15 mm, further, the number of blades is selected as 5 pieces; for another example, the effective length of the blade is 50 mm-60 mm, taking the multi-layer blade as an example, the number of layers of the blade is 3-5 layers, the effective length of the bottommost layer blade is 50 mm, the effective length of the topmost layer blade is 60 mm, further, the number of blades in each layer is selected as 3-5 pieces.

It should be noted that, considering that the blade is disposed on the cutting disc, and the linear velocity of the blade is also related to the effective length of the blade, that is to say, the effective length of the blade also affects the linear velocity. For example, at the same rotation speed, the longer the length of the blade is, the greater the linear velocity of the blade is. Therefore, in order to increase the linear velocity, an increase may also be achieved by increasing the effective length of the blade. Considering that grass cannot be cut when the linear velocity is too small, which in turn affects the cutting efficiency. Therefore, the effective length of the blade should not be too small, in some embodiments, the effective length of the blade is greater than 5 mm. Considering that the blade is prone to breakage when the linear velocity is too large, therefore, the effective length of the blade should not be too large, in some embodiments, the effective length of the blade is less than or equal to 70 mm. Considering that for some large-volume lawn mowers, such as the commercial lawn mower, the cutting efficiency and the cutting quality requirement are high, therefore the effective length requirement of the blade is higher, therefore the effective length cannot be too short, therefore, in some embodiments, the effective length of the blade is greater than or equal to 30 mm. It can be understood that, considering that the effective length becomes longer, the blade body hardness is relatively softer.

In summary, in some embodiments, the effective length of the blade is greater than or equal to 5 mm, and less than or equal to 70 mm. Further, the effective length of the blade is greater than or equal to 30 mm, and less than or equal to 70 mm. For example, the effective length of the blade is 5-6 mm, further, the number of blades is selected as 5-6 pieces to improve the cutting quality. For another example, the effective length of the blade is 15 mm, further, the number of blades may be selected as 5 pieces to improve the cutting quality. For another example, the effective length of the blade is 50 mm-60 mm, taking the multi-layer blade as an example, the number of layers of the blade is 3-5 layers, the effective length of the bottommost layer blade is 50 mm, the effective length of the topmost layer blade is 60 mm, further, the number of blades in each layer is selected as 3-5 pieces.

It should be pointed out that the overall length of the blade is equal to the sum of the effective length of the blade and a blade installation length, in some embodiments the blade installation length is usually in the range of 10-15 mm. Therefore, the overall length of the blade is equal to the effective length of the blade plus (10-15) mm; wherein, the blade installation length refers to, for example, the length of the blade installed on the cutting disc or the length of the blade that cannot extend from the cutting disc.

Considering that the manufacturing difficulty is high when the blade thickness is too thick, therefore, the blade should not be too thick, in some embodiments, the blade thickness is less than or equal to 5 mm. Further, the blade thickness is less than or equal to 2 mm. Considering that the risk of blade breakage also increases when the blade thickness is too thin, therefore, the blade should not be too thin, in some embodiments, the blade thickness is greater than or equal to 0.5 mm. Further, the blade thickness is greater than or equal to 0.9 mm.

From the above, it can be known that the blade cannot be made too thin nor too thick, therefore, in some embodiments, the blade thickness is greater than or equal to 0.5 mm, and less than or equal to 5 mm. Further, the blade thickness is greater than or equal to 0.5 mm, and less than or equal to 2 mm. In some embodiments, the blade thickness is greater than or equal to 0.9 mm, and less than or equal to 5 mm. Further, the blade thickness is greater than or equal to 0.9 mm, and less than or equal to 2 mm.

In summary, for example, the blade thickness may be selected as 0.6 mm, 0.9 mm, 1.2 mm, etc.

From the above, it can be known that the present disclosure provides the lawn mower that reduces the risk of blade breakage by reducing the hardness of the blade body, or simultaneously improving the hardness of the blade body and the hardness of the cutting portion, when the travel speed increases and the linear velocity improves, on the premise that the blade thickness cannot be too thick and the length of the blade extending from the cutting disc cannot be too short.

The lawn mower, especially the commercial lawn mower, has a fast travel speed and a high linear velocity, but the blade thickness cannot be too thick and the length of the blade extending from the cutting disc cannot be too small; therefore the blade body should be softer. For example, the lawn mower with the travel speed greater than 0.8 m/s; for another example, the lawn mower with the travel speed greater than 1.5 m/s, and the blade effective length of 5-70 mm;

Considering a large lawn mower with the fast travel speed and higher cutting quality and efficiency, but the blade thickness cannot be too thick, the length of the blade extending from the cutting disc cannot be too small, and the blade is longer compared with a small machine; therefore the blade body is softer, for example, a machine with a travel speed greater than 1.5 m/s, and the blade length of 30-70 mm.

Based on the above discussion, referring to Table 1, the parameter range of the lawn mower provided by the present disclosure may be selected and combined from the following parameter ranges:

The parameter range of the travel speed: a range A: greater than or equal to 1 m/s; a range A1: greater than or equal to 1.5 m/s; a range A2: greater than or equal to 2 m/s; for example: 2 m/s.

The parameter range of the linear velocity (m/s): a range B is 30-70 m/s; a range B1 is 40-60 m/s;

The parameter range of the blade body hardness (HRC): a range E is 5-45; a range E1 is 10-30; a range E2 is 10-25;

Further, the hardness range of the blade cutting portion (HRC): a range F is greater than or equal to 50 HRC; a range F1 is greater than or equal to 60 HRC.

Further, the parameter range of the effective length of the blade: a range C is greater than or equal to 5 mm; a range C1 is 5-70 mm; a range C2 is 30-70 mm;

Further, the number range of the blade is 3-5 pieces.

It should be noted that the range E1 of the blade body hardness is applicable to a machine with the travel speed greater than 1.5 m/s, and the blade length of 5-70 mm; the range E2 is applicable to a machine with the travel speed greater than 1.5 m/s, and the blade length of 30-70 mm.

Further, the parameter range of the blade thickness: a range D is 0.5-5 mm; a range D1 is 0.5-2 mm; a range D2 is 0.9-5 mm; a range D3 is 0.9-2 mm.

Referring to Table 1, the present disclosure provides four examples, namely the lawn mower of a first example, the lawn mower of a second example, the lawn mower of a third example, and the lawn mower of a fourth example;

Wherein, the lawn mower parameter in the first example is: the travel speed is greater than or equal to 1 m/s, for example the travel speed is 1 m/s; the linear velocity is around 34 m/s; when the effective length of the blade is 15 mm, the hardness of the blade body is 40 HRC;

Further, the hardness of the blade cutting portion is 60-70 HRC.

Further, the thickness of the blade is 0.9 mm.

The lawn mower parameter in the second example is: the travel speed is greater than or equal to 1.5 m/s, for example the travel speed is 2 m/s; the linear velocity is around 44 m/s; when the effective length of the blade is 15 mm, the hardness of the blade body is 20-30 HRC.

Further, the hardness of the blade cutting portion is 60-70 HRC

Further, the thickness of the blade is 0.9 mm.

Further, the number of blades is 5, to improve the cutting quality.

The lawn mower parameter in the third example is: the travel speed is greater than or equal to 1.5 m/s, for example the travel speed is 2 m/s; the linear velocity is around 48 m/s; when the effective length of the blade is 50-60 mm, the hardness of the blade body is 10-20 HRC;

Further, the hardness of the blade cutting portion is 60-70 HRC.

Further, the thickness of the blade is 1.2 mm.

Further, the blade is the multi-layer blade, the effective length of the bottommost layer blade is 50 mm, and the effective length of the topmost layer blade is 60 mm;

Further, the number of blades in each layer is 3, to improve the cutting quality.

The lawn mower parameter in the fourth example is: the travel speed is greater than or equal to 1 m/s, for example the travel speed is 1 m/s; the linear velocity is around 38 m/s; when the effective length of the blade is 5 mm, the hardness of the blade body is 40 HRC;

Further, the hardness of the blade cutting portion is 60-70 HRC.

Further, the thickness of the blade is 0.6 mm.

Further, the number of blades is 5, to improve the cutting quality.

It should be understood that when a parameter value is a range, the parameter value indicates that the parameter may be selected within the range.

Further, the blade body has a first area, the cutting portion has a second area, and the area of the blade body is greater than the area of the cutting portion.

Further, the blade body comprises at least two regions with different hardness.

Further, the cutting portion comprises at least two regions with different hardness.

Further, the number of different hardness regions of the blade body is greater than the number of different hardness regions of the cutting portion.

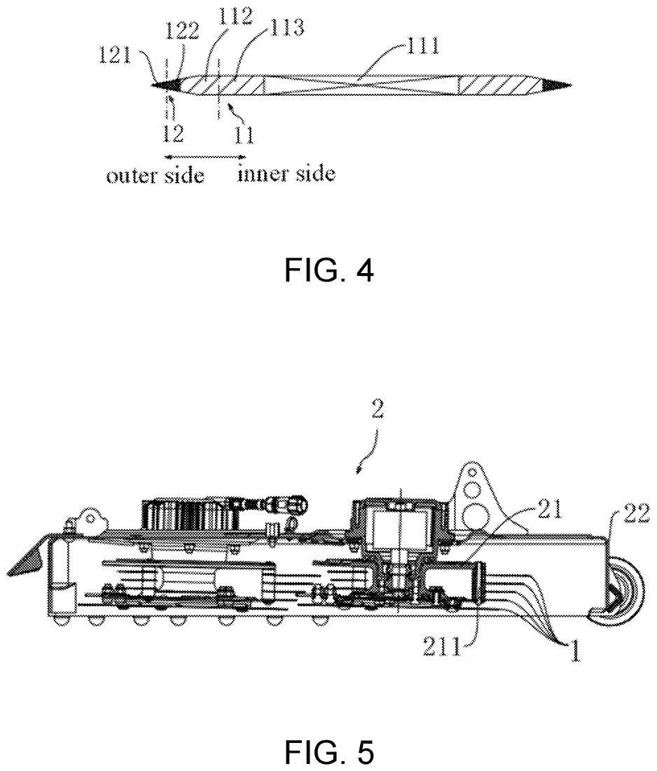

Referring to FIG. 4, in an example embodiment, the blade body 11 comprises a first hardness region 112 and a second hardness region 113, the first hardness region 112 is located on an outer side of the blade body 11, the second hardness region 113 is located on an inner side of the blade body 11, and the hardness of the first hardness region 112 is greater than the hardness of the second hardness region 113. Wherein, setting the blade body 11 as two hardness regions, the hardness of the first hardness region 112 is set to be relatively high, which is beneficial for the blade body 11 to cut grass, and the hardness of the second hardness region 113 is set to be lower than the hardness of the first hardness region 112, which is beneficial for the first hardness region 112 to transfer the impact force received when cutting the grass to the second hardness region 113, helps the first hardness region 112 to release a force, and may effectively prevent the breakage of the blade 1.

In some embodiments, the area of the first hardness region 112 is smaller than the area of the second hardness region 113, setting a larger area for the less hard region to improve the force-releasing effect of the harder region. In another embodiments, the area of the first hardness region 112 may also be set to be greater than or equal to the area of the second hardness region 113.

In other embodiments, the blade body 11 may also comprise another one or more regions with different hardness in addition to the first hardness region 112 and the second hardness region 113. Within a certain range, the more hardness regions the blade body 11 is divided into, the better the force-releasing effect for the impact force received by the blade 1. However, the more regions with different hardness the blade body 11 is divided into, the higher the manufacturing cost of the blade 1 is, and a different usage environment has a different requirement for the number of hardness region divisions of the blade 1, and the number of different hardness regions of the blade body 11 may be set according to a usage condition.

Please also refer to FIG. 4, in an example embodiment, the cutting portion 12 comprises a third hardness region 121 and a fourth hardness region 122, the third hardness region 121 is located on an outer side of the cutting portion 12, the fourth hardness region 122 is located on an inner side of the cutting portion 12, and the hardness of the third hardness region 121 is greater than the hardness of the fourth hardness region 122. Setting the hardness of the fourth hardness region 122 to be lower than the hardness of the third hardness region 121 is beneficial for the third hardness region 121 to transfer the impact force received by the third hardness region 121 to the fourth hardness region 122, helps the third hardness region 121 to release a force, and may effectively prevent the breakage of the blade 1.

In some embodiments, the area of the third hardness region 121 is lower than the area of the fourth hardness region 122, setting a larger area for the less hard region to improve the force-releasing effect of the harder region. In other embodiments, the area of the third hardness region 121 may also be set to be greater than or equal to the area of the fourth hardness region 122.

In other embodiments, the cutting portion 12 may also comprise another one or more regions with different hardness in addition to the third hardness region 121 and the fourth hardness region 122. Within a certain range, the more hardness regions the cutting portion 12 is divided into, the better the force-releasing effect for the impact force received by the blade 1. And the more regions with different hardness the cutting portion 12 is divided into, the higher the manufacturing cost of the blade 1 is, and a different usage environment has a different requirement for the number of hardness region divisions of the blade 1, and the number of different hardness regions of the cutting portion 12 may be set according to a usage condition.

In some embodiments, the number of different hardness regions of the blade body 11 is greater than the number of different hardness regions of the cutting portion 12. Generally, the area of the blade body 11 is greater than the area of the cutting portion 12, making the blade body 11 more convenient than the cutting portion 12 for dividing into more regions with different hardness. A setting of more different hardness regions on the blade body 11 makes the force-releasing effect of the blade 1 better.

In other embodiments, the number of different hardness regions of the blade body 11 may be equal to or smaller than the number of different hardness regions of the cutting portion 12.

Please refer to FIG. 5, it should be understood that the outer side and the inner side described in the present disclosure are based on the blade 1 as a whole, a setting direction toward the edge of the blade 1 is the outer side, and a setting direction toward the interior of the blade 1 is the inner side.

In some embodiments, the width of the cutting portion 12 may be in a range of [0.1 mm, 5 mm]. A setting of the width of the cutting portion 12 only needs to ensure the cutting requirement of the cutting portion 12, and ensure that the cutting portion 12 can be reliably connected with the blade body 11, so that the production cost of a blade 1 can be greatly reduced under the premise of ensuring the wear-resistant strength of the blade 1. Specifically, the width of the cutting portion may be 0.1 mm, 1 mm, 2 mm or 5 mm, etc.

In some embodiments, the blade 1 is made from a single piece of plate material, and by performing different degrees of hardening treatment such as laser quenching, edge carburizing or induction hardening on the blade body 11 and the cutting portion 12, the blade body 11 and the cutting portion 12 each having different hardness regions are obtained, to meet the high toughness requirement of the blade body 11 while meeting the high wear-resistance usage requirement of the cutting portion 12.

In some embodiments, the blade 1 may be formed from a single plate material, and the metal grains of the blade body 11 become denser through quenching and tempering treatment, so that the impact resistance of the blade body 11 is improved. The cutting portion is hardened by adopting a laser quenching process on the edge, thereby obtaining the blade 1 with the hardness of the cutting portion higher than the hardness of the blade body 11. However, in other embodiments, the laser quenching may also be replaced by other processes, such as edge carburizing, induction hardening, etc.

In other embodiments, the blade body 11 may be set as an integral body having different hardness regions, the cutting portion 12 may be set as a plurality of components having different hardness, and the plurality of components of different hardness materials of the cutting portion 12 are fixedly connected and then connected to the blade body 11. Such a configuration facilitates force release inside the blade 1. In other embodiments, the blade body 11 may also be set as a plurality of components having different hardness, the cutting portion 12 may be set as an integral body having different hardness regions, and the plurality of components of different hardnesses of the blade body 11 are fixedly connected and then connected with the cutting portion 12. This configuration also facilitates the force release inside the blade 1.

In other embodiments, different hardness regions of the blade body 11 are made of different materials, and different hardness regions of the cutting portion 12 are also made of different materials. The blade body 11 and the cutting portion 12 may be directly formed as an integral body during molding, forming a plurality of connected components with different hardness. In addition, the cutting portion 12 and the blade body 11 may also be formed separately, forming a plurality of components with different hardness, and then the plurality of components with different hardness are fixedly connected together. In this embodiment, the plurality of components of a different hardness of the cutting portion 12 and the plurality of components with different hardness of the blade body 11 are formed separately, and then the plurality of components are fixedly connected together through welding or another method.

It should be noted that the component with different hardness of the cutting portion are connected into an integral body, and the plurality of components with different hardness of the blade body are connected into an integral body; finally the cutting portion connected as an integral body and the blade body connected as an integral body are connected, and the above connection method may adopt the same method, such as welding, adhesive connection, self-locking fastener connection, etc., which is not be described in detail in this embodiment. However, in other embodiments, the above connection method may also adopt different connection methods. In other words, among the connection method of the component with different hardness of the cutting portion, the connection method of the plurality of components with different hardness of the blade body, and the connection method between the integrally connected cutting portion and the integrally formed blade body; there exist at least two different connection methods among these three connection methods. For example, when there are two connection methods, 1) the connection method of the component with different hardness of the cutting portion and the connection method of the plurality of components with different hardness of the blade body adopt a first connection method, and the connection method between the cutting portion and the blade body is different from the connection method of the component with different hardness of the cutting portion. That is to say, the connection method between the cutting portion and the blade body adopts a second connection method, and the second connection method is different from the first connection method; 2) the connection method of the component with different hardness of the cutting portion, and the connection method of the cutting portion and the blade body adopt the first connection method, and the connection method of the plurality of components with different hardness of the blade body is different from the connection method of the component with different hardness of the cutting portion. That is to say, the connection method of the plurality of components with different hardness of the blade body adopts the second connection method, and the second connection method is different from the first connection method; 3) the connection method of the component with different hardness of the cutting portion adopts the first connection method, and the connection method between the cutting portion and the blade body, and the connection method of the plurality of components with different hardness of the blade body adopt a method different from the connection method of the component with different hardness of the cutting portion. That is to say, the connection method of the plurality of components with different hardness of the blade body, and the connection method between the cutting portion and the blade body both adopt the second connection method, and the second connection method is different from the first connection method.

The above first connection method adopts, for example, welding, and the second connection method adopts, for example, adhesive connection or self-locking fastener connection; or, the first connection method adopts, for example, adhesive connection, and the second connection method adopts, for example, welding or self-locking fastener connection; or, the first connection method adopts, for example, self-locking fastener connection, and the second connection method adopts, for example, welding or adhesive connection.

When there are three connection methods, that is, the connection method of the component with different hardness of the cutting portion is different from the connection method of the plurality of components with different hardness of the blade body, the connection method of the plurality of components with different hardness of the blade body is different from the connection method between the cutting portion and the blade body, and the connection method between the cutting portion and the blade body is different from the connection method of the component with different hardness of the cutting portion, that is to say, the connection method of the component with different hardness of the cutting portion adopts the first connection method, the connection method of the plurality of components with different hardness of the blade body adopts the second connection method, the connection method between the cutting portion and the blade body adopts a third connection method, and the three connection methods are all different. For example, the first connection method adopts, for example, welding, the second connection method adopts one of adhesive connection and self-locking fastener connection, and the third connection method adopts another one of the adhesive connection and the self-locking fastener connection; for another example, the first connection method adopts adhesive connection, the second connection method adopts one of welding and self-locking fastener connection, and the third connection method adopts another one of the welding and the self-locking fastener connection; for another example, the first connection method adopts self-locking fastener connection, the second connection method adopts one of welding and adhesive connection, and the third connection method adopts another one of the welding and the adhesive connection.

The connection between the cutting portion and the blade body adopts welding, and the connection of the component with different hardness of the cutting portion (and/or the blade body) adopts adhesive (or self-locking fastener) connection.

The connection between the cutting portion and the blade body adopts welding, and the connection of the component with different hardness of the cutting portion (and/or the blade body) adopts adhesive (or self-locking fastener) connection.

As shown in FIG. 5, in some embodiments, one end of the blade body 11 is provided with the rotating shaft mounting hole 111 for mounting the rotating shaft 211, and the hardness of the rotating shaft 211 is greater than the hardness of the blade body 11. This can reduce wear of the rotating shaft 211, and during long-term use, can reduce wear between the rotating shaft 211 and the blade body 11, thereby reducing the frequency of the blade 1 replacement. Generally, since the cutting portion 12 has significant wear during a cutting operation, before the cutting portion 12 wears out and cannot work, replacement of the blade 1 due solely to the wear between the rotating shaft 211 and the blade body 11 basically does not occur.

As shown in FIG. 1, in some embodiments, the blade 1 of the present disclosure further comprises a dulling zone 13 for gripping the blade body 11, and the dulling zone 13 is disposed on the blade body 11 at one end close to the rotating shaft mounting hole 111. The dulling zone 13 is not provided with a cutting edge like the cutting portion 12, in order to facilitate an operator to hold the dulling zone 13 for replacement or a maintenance of the blade 1.

However, in other embodiments, this can also be achieved by increasing the difference in hardness between the blade body and the cutting portion, for example, the hardness of the cutting portion is greater than the hardness of the blade body, and the difference between the hardness of the cutting portion and the hardness of the blade body is greater than or equal to 40 HRC, and less than or equal to 80 HRC.

TABLE 1

| | | | extension | | | |
|---|---|---|---|---|---|---|
| | | | length of | | | |
| | | | blade from | | | |
| | | | cutting | | | |
| | | | disc | | | |
| | | | (effective | | | hardness |
| | Travel | linear | length of | blade | hardness of | of cutting |
| Influencing | speed | velocity | blade: | thickness | blade body | edge |
| Factors | (m/s) | (m/s) | mm) | (mm) | (HRC) | (HRC) |
| constraint | Travel | It is too | It is too | It is too | If the | If the |
| conditions | speed | low, the | long, the | thick, the | hardness is | hardness is |
| | affects | grass | blade is | manufacturing | too low, it is | too low, |
| | cutting | cannot be | prone to | difficulty | prone to | the wear |
| | efficiency | cut; if it is | breakage; | is high; if | bending; if | resistance |
| | | too high, | it is too | too thin, | too high, it | is poor; if |
| | | the blade is | short, the | the blade is | is prone to | too high, it |
| | | prone to | mowing | prone to | breakage. | is limited |
| | | breakage. | quality will | breakage. | | by the |
| | | | decrease | | | process |
| | | | and the | | | and |
| | | | grass | | | material. |
| | | | cannot be | | | |
| | | | cut. | | | |
| parameter | range A: ≥1 | range B: | range | range D: | range E: 5- | range |
| ranges | m/s; | 30-70 | C: ≥5 mm; | 0.5-5 | 45; | F: ≥50 |
| | range | m/s; | range | mm; | range E 1: | HRC; |
| | A1: ≥1.5 m/s; | range | C1: 5-70 | range D1: | 10-30 | range |
| | range | B1: 40-60 | mm; | 0.5-2 | range E 2: | F1: ≥60 |
| | A2: ≥2 m/s; | m/s | range | mm; | 10-25 | HRC; |
| | for | | C2: 30-70 | range | | |
| | example: | | mm | D2: 0.9-5 | | |
| | 2 m/s | | | mm; | | |
| | | | | range D3: | | |
| | | | | 0.9-2 | | |
| | | | | mm; | | |
| examples | first and | first lawn | first lawn | first lawn | first and | first, |
| | fourth | mower: | mower: 15 | mower: 0.9 | fourth lawn | second, |
| | lawn | approx. 34 | mm; | mm; | mower: 40 | third, |
| | mower: ≥1 | m/s; | second | second | HRC; | fourth |
| | m/s; | second | lawn | lawn | second lawn | lawn |
| | second and | lawn | mower: 15 | mower: 0.9 | mower: 20- | mowers: |
| | third lawn | mower | mm; 5 | mm; | 30 HRC | 60-70 |
| | mower: ≥1.5 | (travel | blades; | third lawn | third lawn | HRC |
| | m/s | speed 2 | third lawn | mower: 1.2 | mower: 10- | |
| | | m/s): | mower: | mm; | 20 HRC | |
| | | approx. 44 | lowest- | fourth | | |
| | | m/s; | layer | lawn | | |
| | | third lawn | blade: 50 | mower: 0.6 | | |
| | | mower | mm; | mm | | |
| | | (travel | uppermost- | | | |
| | | speed 2 | layer | | | |
| | | m/s, multi- | blade: 60 | | | |
| | | layer | mm; 3 | | | |
| | | blade): | blades per | | | |
| | | approx. 49 | layer; | | | |
| | | m/s; | fourth | | | |
| | | fourth | lawn | | | |
| | | lawnmower | mower: 6 | | | |
| | | (travel | mm; 5 | | | |
| | | speed 1 | blades for | | | |
| | | m/s): | improved | | | |
| | | approx. 38 | cutting | | | |
| | | m/s | quality | | | |

Remark: The meaning of “around” after a numerical value in the table and the foregoing description can be understood as measurement error, which is related to measurement accuracy. For example, the measurement error is within ±5 (for example ±4, or ±3, or even ±1).

A power tool such as the lawn mower has a phenomenon of blade breakage when the blade hits a hard object such as a stone.

In order to improve cutting quality, the linear velocity of the lawn mower usually needs to be increased, for example, to meet the cutting quality requirement for an increased linear velocity caused by a faster travel speed, and of course, it can also meet the cutting quality requirement of the lawn mower which the linear velocity needs to be adaptively increased due to another factor (such as a larger blade size, the multi-layer blade).

However, when the linear velocity increases, the risk of blade breakage increases, therefore, how to reduce the blade breakage problem caused by the increased linear velocity is an issue to be solved for lawn mowers, especially large lawn mowers in commercial scenarios (such as riding lawn mowers).

The applicant has found that while the linear velocity increases, in order to reduce the risk of blade breakage, in a first aspect, the blade thickness may be increased, but considering that the manufacturing difficulty is high due to an excessively thick blade, the blade thickness should not be too thick.

It should be noted that the thicker the blade is, the higher the blade body hardness can be, but existing process cannot achieve an excessively thick blade thickness.

In a second aspect, the effective length of the blade may be shortened, but considering that grass cannot be cut when the effective length of the blade is too short, the effective length of the blade should not be too short.

That is to say, the shorter the length of the blade extending from the cutting disc is, the less likely the blade is to break, but when the length of the blade extending from the cutting disc is too short, grass cannot be cut, and a cutting quality decreases.

In a third aspect, the hardness of the blade may be addressed by improving the blade body, for example, making the blade body softer, that is, reducing the hardness of the blade body so that the blade body has better toughness; or simultaneously improving the hardness of the blade body and the hardness of the cutting portion, for example, reducing the hardness of the blade body and increasing the hardness of the cutting portion, so that the blade can meet both toughness and wear-resistance requirements.

It should be pointed out that in other embodiments, the force of the cutting portion may also be released to the blade body by increasing the difference in hardness between the blade body and the cutting portion.

However, the applicant considered the problems existing in solving the blade breakage through the first aspect and the second aspect, therefore, the applicant mainly addresses the blade breakage problem caused by the increased linear velocity through the third aspect.

That is to say, the present disclosure, given that when the linear velocity increases, but the blade thickness cannot be too thick and the length of the blade extending from the cutting disc cannot be too short, reduces the risk of blade breakage by reducing the hardness of the blade body. It should be pointed out that in other embodiments, when the linear velocity increases, the risk of blade breakage may also be reduced by increasing the difference in hardness between the blade body and the cutting portion.

The following provides a detailed description of the requirement for the blade body hardness, the requirement for the cutting portion hardness, or the requirement for the hardness of the blade body and the cutting portion when the blade linear velocity increases.

In some embodiments, when the linear velocity of the blade is greater than or equal to a set value, wherein the set value is 30 m/s; on one hand, the hardness of the blade may be made softer by controlling the hardness of the blade body, for example, when the linear velocity of the blade is greater than or equal to 30 m/s, the hardness of the blade body is controlled to be below 45 HRC; that is, the hardness of the blade body is less than or equal to 45 HRC. Further, when the linear velocity of the blade is greater than or equal to 30 m/s, the hardness of the blade body is less than or equal to 30 HRC. Further, when the linear velocity of the blade is greater than or equal to 30 m/s, the hardness of the blade body is less than or equal to 25 HRC.

Considering that the blade body is prone to bending when the hardness of the blade body is too small, therefore, the hardness of the blade body should not be too small, in some embodiments, when the linear velocity of the blade is greater than or equal to 30 m/s, the hardness of the blade body is greater than or equal to 5 HRC. Further, when the linear velocity of the blade is greater than or equal to 30 m/s, the hardness of the blade body is greater than or equal to 10 HRC.

From the above, it can be known that, in some embodiments, when the linear velocity of the blade is greater than or equal to 30 m/s, the hardness of the blade body is greater than or equal to 5 HRC, and less than or equal to 45 HRC.

In some embodiments, when the linear velocity of the blade is greater than or equal to 30 m/s, the hardness of the blade body is greater than or equal to 10 HRC, and less than or equal to 30 HRC. For example, when the linear velocity of the blade is greater than or equal to 40 m/s, the hardness range of the blade body is 10-30 HRC.

In some embodiments, when the linear velocity of the blade is greater than or equal to 30 m/s, the hardness of the blade body is greater than or equal to 10 HRC, and less than or equal to 25 HRC. For example, when the linear velocity of the blade is greater than or equal to 40 m/s, the hardness range of the blade body is 10-25 HRC.

Considering that an excessively high linear velocity will increase the risk of the blade easily hits a hard object and breaks, therefore in some embodiments, the linear velocity of the blade is less than or equal to 70 m/s. Further, the linear velocity of the blade is less than or equal to 60 m/s. Furthermore, the linear velocity is less than or equal to 50 m/s.

Therefore, in some embodiments, when the linear velocity of the blade is greater than or equal to 30 m/s, and less than or equal to 70 m/s, the hardness of the blade body is greater than or equal to 5 HRC, and less than or equal to 45 HRC. For example, when the linear velocity of the blade is 34-35 m/s, the hardness of the blade body is 40 HRC.

In some embodiments, when the linear velocity of the blade is greater than or equal to 40 m/s, and less than or equal to 60 m/s, the hardness of the blade body is greater than or equal to 10 HRC, and less than or equal to 30 HRC. For example, when the linear velocity of the blade is equal to 44 m/s-45 m/s, the hardness of the blade body is 20-30 HRC. For another example, when the linear velocity of the blade is equal to 49 m/s-50 m/s, the hardness of the blade body is 10-20 HRC.

In some embodiments, when the linear velocity of the blade is greater than or equal to 40 m/s, and less than or equal to 60 m/s, the hardness of the blade body is greater than or equal to 10 HRC, and less than or equal to 25 HRC. For example, when the linear velocity of the blade is equal to 49 m/s-50 m/s, the hardness of the blade body is 10-20 HRC.

In some embodiments, when the linear velocity of the blade is greater than or equal to 40 m/s, and less than or equal to 50 m/s, the hardness of the blade body is greater than or equal to 10 HRC, and less than or equal to 25 HRC. For example, when the linear velocity of the blade is equal to 49 m/s-50 m/s, the hardness of the blade body is 10-20 HRC.

Considering that the cutting portion is not wear-resistant if the hardness of the cutting portion is too low, and the cutting portion is limited by process materials if the hardness of the cutting portion is too high, in other words, the higher the hardness of the cutting portion, the more wear-resistant the cutting portion is, but current processes cannot achieve an extremely high hardness. In summary, in order to make the cutting portion meet the wear-resistance requirement, therefore, in some embodiments, the hardness of the cutting portion may be controlled to meet the wear-resistance requirement. For example, when the linear velocity of the blade is greater than or equal to 30 m/s, the hardness of the cutting portion is greater than or equal to 50 HRC; further, when the linear velocity of the blade is greater than or equal to 30 m/s, the hardness of the cutting portion is greater than or equal to 55 HRC; for example, when the linear velocity of the blade is greater than or equal to 34 m/s, the hardness of the cutting portion is greater than or equal to 55 HRC. Furthermore, when the linear velocity of the blade is greater than or equal to 30 m/s, the hardness of the cutting portion is greater than or equal to 60 HRC. For example, when the linear velocity of the blade is greater than or equal to 40 m/s, the hardness of the cutting portion is greater than or equal to 60 HRC.

Considering current process limitations, the hardness of the cutting portion cannot be made extremely high. Therefore, in some embodiments, when the linear velocity of the blade is greater than or equal to 30 m/s, the hardness of the cutting portion is less than or equal to 80 HRC. Further, when the linear velocity of the blade is greater than or equal to 30 m/s, the hardness of the cutting portion is less than or equal to 75 HRC. For example, when the linear velocity of the blade is greater than or equal to 34 m/s, the hardness of the cutting portion is less than or equal to 75 HRC. Furthermore, when the linear velocity of the blade is greater than or equal to 30 m/s, the hardness of the cutting portion is less than or equal to 70 HRC. For example, when the linear velocity of the blade is greater than or equal to 40 m/s, the hardness of the cutting portion is less than or equal to 70 HRC.

From the above, it can be known that, in some embodiments, when the linear velocity of the blade is greater than or equal to 30 m/s, the hardness of the cutting portion is greater than or equal to 50 HRC, and less than or equal to 80 HRC.

In some embodiments, when the linear velocity of the blade is greater than or equal to 30 m/s, the hardness of the cutting portion is greater than or equal to 55 HRC, and less than or equal to 75 HRC.

In some embodiments, when the linear velocity of the blade is greater than or equal to 30 m/s, the hardness of the cutting portion is greater than or equal to 60 HRC, and less than or equal to 70 HRC.

Considering that an excessively high linear velocity will increase the risk that the blade easily hits a hard object and breaks. Therefore, in some embodiments, the linear velocity of the blade is less than or equal to 70 m/s. Further, the linear velocity of the blade is less than or equal to 60 m/s. Furthermore, the linear velocity is less than or equal to 50 m/s.

In some embodiments, when the linear velocity of the blade is greater than or equal to 30 m/s, and less than or equal to 70 m/s, the hardness of the cutting portion is greater than or equal to 50 HRC.

In some embodiments, when the linear velocity of the blade is greater than or equal to 40 m/s, and less than or equal to 60 m/s, the hardness of the cutting portion is greater than or equal to 55 HRC.

In some embodiments, when the linear velocity of the blade is greater than or equal to 40 m/s, and less than or equal to 50 m/s, the hardness of the cutting portion is greater than or equal to 60 HRC.

In summary, in some embodiments, when the linear velocity of the blade is greater than or equal to 30 m/s, and less than or equal to 70 m/s, the hardness of a cutting portion is greater than or equal to 50 HRC, and less than or equal to 80 HRC. For example, when the linear velocity of the blade is 34-35 m/s, the hardness of the blade body is 60-70 HRC.

In some embodiments, when the linear velocity of the blade is greater than or equal to 40 m/s, and less than or equal to 60 m/s, the hardness of the cutting portion is greater than or equal to 55 HRC, and less than or equal to 75 HRC. For example, when the linear velocity of the blade is equal to 44 m/s-45 m/s, the hardness of the cutting portion is 60-70 HRC. For another example, when the linear velocity of the blade is equal to 49 m/s-50 m/s, the hardness of the cutting portion is 60-70 HRC.

In some embodiments, when the linear velocity of the blade is greater than or equal to 40 m/s, and less than or equal to 50 m/s, the hardness of the cutting portion is greater than or equal to 60 HRC, and less than or equal to 70 HRC. For example, when the linear velocity of the blade is equal to 44 m/s-45 m/s, the hardness of the cutting portion is 60-70 HRC. For another example, when the linear velocity of the blade is equal to 49 m/s-50 m/s, the hardness of the cutting portion is 60-70 HRC.

In some embodiments, in order to meet the toughness requirement of the blade body and the wear-resistance requirement of the cutting portion, the hardness of the blade body and the hardness of the cutting portion may be simultaneously improved. For example, when the linear velocity of the blade is greater than or equal to 30 m/s, the hardness of the blade body is 5-45 HRC, and the hardness of the cutting portion is 50 or above. For another example, when the linear velocity of the blade is greater than or equal to 30 m/s, the hardness of the blade body is 10-30 HRC, and the hardness of the cutting portion is 55 or above. For another example, when the linear velocity of the blade is greater than or equal to 30 m/s, the hardness of the blade body is 10-25 HRC, and the hardness of the cutting portion is 60 or above.

Considering current process limitation, the hardness of the cutting portion cannot be made excessively high. Therefore, in some embodiments, for example, when the linear velocity of the blade is greater than or equal to 30 m/s, the hardness of the blade body is 5-45 HRC, and the hardness of the cutting portion is 50-80 HRC. For another example, when the linear velocity of the blade is greater than or equal to 30 m/s, the hardness of the blade body is 10-30 HRC, and the hardness of the cutting portion is 55-75 HRC. For another example, when the linear velocity of the blade is greater than or equal to 30 m/s, the hardness of the blade body is 10-25 HRC, and the hardness of the cutting portion is 60-70 HRC.

Considering that an excessively high linear velocity will increase the risk of the blade easily hits a hard object and breaks. Therefore, in some embodiments, for example, when the linear velocity of the blade is greater than or equal to 30 m/s, and less than or equal to 70 m/s, the hardness of a blade body is 5-45 HRC, and the hardness of a the cutting portion is 50-80 HRC. When the linear velocity of the blade is greater than or equal to 30 m/s, and less than or equal to 70 m/s, the hardness of the blade body is 10-30 HRC, and the hardness of the cutting portion is 55-75 HRC. For another example, when the linear velocity of the blade is greater than or equal to 30 m/s, and less than or equal to 70 m/s, the hardness of the blade body is 10-25 HRC, and the hardness of the cutting portion is 60-70 HRC.

In summary, in some embodiments, when the linear velocity of the blade is greater than or equal to 30 m/s, and less than or equal to 70 m/s, the hardness of the blade body is greater than or equal to 5 HRC, and less than or equal to 45 HRC; the hardness of the cutting portion is greater than or equal to 50 HRC, and less than or equal to 80 HRC. For example, when the linear velocity of the blade is 34-35 m/s, the hardness of the blade body is 40 HRC, and the hardness of the blade body is 60-70 HRC.

In some embodiments, when the linear velocity of the blade is greater than or equal to 40 m/s, and less than or equal to 60 m/s, the hardness of the blade body is greater than or equal to 10 HRC, and less than or equal to 30 HRC; the hardness of a cutting portion is greater than or equal to 55 HRC, and less than or equal to 75 HRC. For example, when the linear velocity of the blade is equal to 44 m/s-45 m/s, the hardness of the blade body is 20-30 HRC; the hardness of the cutting portion is 60-70 HRC. For another example, when the linear velocity of the blade is equal to 49 m/s-50 m/s, the hardness of the cutting portion is 60-70 HRC.

In some embodiments, when the linear velocity of the blade is greater than or equal to 40 m/s, and less than or equal to 50 m/s, the hardness of the blade body is greater than or equal to 10 HRC, and less than or equal to 25 HRC; the hardness of the cutting portion is greater than or equal to 60 HRC, and less than or equal to 70 HRC. For example, when the linear velocity of the blade is equal to 49 m/s-50 m/s, the hardness of the blade body is 10-20 HRC; the hardness of the cutting portion is 60-70 HRC.

Considering that the lawn mower may adopt multi-layer blade, which are usually arranged in a staggered manner, blades in different layers have different cutting radius (or cutting diameter), and the linear velocity is related to the cutting radius (or the cutting diameter) of the blade. Generally speaking, the multi-layer blade is usually arranged in a stepped manner, the more blade layers there are, the higher the linear velocity of the upper layer blade is. That is to say, the linear velocity of the blade is related to the number of layers of the blade, and the linear velocity of the blade affects the cutting quality. Therefore, the lawn mower using the multi-layer blade has higher requirements for the cutting efficiency and the cutting quality. In order to adapt to the cutting requirement of multi-layer blade, in some embodiments, the (minimum) linear velocity of the multi-layer blade is greater than the linear velocity of single-layer blades, especially when another parameter is the same. For example, when the travel speed is the same and/or the blade thickness is the same, the linear velocity when the lawn mower uses the multi-layer blade is greater than the linear velocity when the lawn mower uses the single-layer blades.

Therefore, in some embodiments, when the travel speed is 2 m/s, for the lawn mower with single-layer blades, the linear velocity of the blade is 44 m/s-45 m/s; when the travel speed is 2 m/s, for the lawn mower with multi-layer blade, the linear velocity of the blade is 49 m/s-50 m/s.

It can be understood that, as shown in FIG. 5, for multi-layer blade, along the height direction of the lawn mower, from top to bottom, the diameter of the cutting trajectory of the blade gradually decreases. Therefore, the linear velocity of the blade gradually decreases. In other words, the diameter of the cutting trajectory of an upper blade is larger than that of a lower blade. Therefore, the linear velocity of the upper blade is higher than that of the lower blade. Wherein, for multi-layer blade, the linear velocity of the blade refers to the linear velocity of the bottommost layer blade or the minimum linear velocity.

Considering that multi-layer blade may be arranged in a staggered manner, therefore each layer has a different linear velocity. In some embodiments, in order to reduce the risk of blade breakage, the hardness of the blade (body) with a high linear velocity is less than that with a low linear velocity. For example, for the multi-layer blade distributed in a stepped manner in FIG. 5, from bottom to top, the linear velocity of the blade increases sequentially, therefore from bottom to top, the hardness of the blade body decreases sequentially, to reduce the risk of blade breakage.

Considering that the blade is disposed on the cutting disc, the length of the blade extending from the cutting disc (referred to as the effective length of the blade) affects the lawn mowing efficiency. In other words, in order to improve the lawn mowing efficiency, the effective length of the blade may be increased. When the effective length of the blade is too short, grass cannot be cut, the lawn mowing quality decreases or the lawn mowing effect is poor. Therefore, the effective length of the blade cannot be too short, for example, in some embodiments, the effective length of the blade is greater than or equal to 5 mm. Considering that for some large-volume lawn mowers, such as the commercial lawn mower, the cutting efficiency and the cutting quality requirement are high, therefore the effective length requirement of the blade is higher. Therefore, in some embodiments, the effective length of the blade is greater than or equal to 30 mm.

Considering that the blade is prone to breakage when the length of the blade extending from the cutting disc (referred to as the effective length of the blade) is too long. Therefore, the effective length of the blade cannot be too long. For example, in some embodiments, the effective length of the blade is less than or equal to 70 mm.

In summary, in some embodiments, the effective length of the blade is greater than or equal to 5 mm, and less than or equal to 70 mm. Further, the effective length of the blade is greater than or equal to 30 mm, and less than or equal to 70 mm.

It should be pointed out that, in order to improve the lawn mowing quality or the lawn mowing effect, the multi-blades may be adopted, that is, an improvement of the lawn mowing quality is achieved through the multiple cutting. Therefore, in some embodiments, for the same blade effective length, the cutting quality of the lawn mower using the multi-blade is greater than that of the lawn mower using a single blade. For example, the effective length of the blade is 5-6 mm, further, the number of blades is selected as 5-6 pieces, to improve the cutting quality. For another example, the effective length of the blade is 15 mm, further, the number of blades is selected as 5 pieces. For another example, the effective length of the blade is 50 mm-60 mm, taking the multi-layer blade as an example, the number of layers of the blade is 3-5 layers, the effective length of the bottommost layer blade is 50 mm, the effective length of the topmost layer blade is 60 mm, further, the number of blades in each layer is selected as 3-5 pieces.

It should be noted that, considering that the blade is disposed on the cutting disc, and the linear velocity of the blade is also related to the effective length of the blade. That is to say, the effective length of the blade also affects the linear velocity. For example, for the same rotation speed, the longer the effective length of the blade is, the higher the linear velocity of the blade is. Therefore, in order to increase the linear velocity, an increase may also be achieved by increasing the effective length of the blade. Considering that grass cannot be cut when the linear velocity is extremely low, which in turn affects the cutting efficiency. Therefore, the effective length of the blade should not be extremely short. In some embodiments, the effective length of the blade is greater than 5 mm. Considering that the blade is prone to breakage when the linear velocity is extremely high, therefore, the effective length of the blade should not be extremely long. In some embodiments, the effective length of the blade is less than or equal to 70 mm. Considering that for some large-volume lawn mowers, such as the commercial lawn mower, the cutting efficiency and the cutting quality requirement are high, therefore the effective length requirement of the blade is higher, the effective length cannot be extremely short. Therefore, in some embodiments, the effective length of the blade is greater than or equal to 30 mm. It can be understood that, considering that the effective length becomes longer, the blade body hardness is relatively lower.

In summary, in some embodiments, the effective length of the blade is greater than or equal to 5 mm, and less than or equal to 70 mm. Further, the effective length of the blade is greater than or equal to 30 mm, and less than or equal to 70 mm. For example, the effective length of the blade is 5-6 mm, further, the number of blades is selected as 5-6 pieces to improve the cutting quality. For another example, the effective length of the blade is 15 mm, further, the number of blades may be selected as 5 pieces to improve the cutting quality. For another example, the effective length of the blade is 50 mm-60 mm, taking the multi-layer blade as an example, the number of layers of the blade is 3-5 layers, the effective length of the bottommost layer blade is 50 mm, the effective length of the topmost layer blade is 60 mm, further, the number of blades in each layer is selected as 3-5 pieces.

And in order to adapt to the increased risk of blade breakage that the longer blade (for the lawn mower with the extremely high requirement for the cutting efficiency and the cutting quality) may bring, therefore, in some embodiments, the hardness of the blade body should be lower. For example, the blade body hardness when the effective length of the blade is equal to 30 mm is less than a blade body hardness when the effective length of the blade is equal to 5 mm. In other words, the longer the effective length of the blade, the lower the hardness of the blade body.

For example, in some embodiments, when the effective length of the blade is greater than or equal to 5 mm, and less than or equal to 70 mm, the hardness of the blade body is greater than or equal to 10 HRC, and less than or equal to 30 HRC. And when the effective length of the blade is greater than or equal to 30 mm, and less than or equal to 70 mm, the hardness of the blade body is greater than or equal to 10 HRC, and less than or equal to 25 HRC.

Further considering the lawn mower with higher cutting quality requirements, the linear velocity of the blade is relatively larger and/or the effective length of the blade is relatively longer.

Therefore, in some embodiments, when the linear velocity of the blade is greater than or equal to 40 m/s, and less than or equal to 60 m/s, and the effective length of the blade is greater than or equal to 5 mm, and less than or equal to 70 mm, the hardness of the blade body is greater than or equal to 10 HRC, and less than or equal to 30 HRC. And when the linear velocity of the blade is greater than or equal to 40 m/s, and less than or equal to 60 m/s, and the effective length of the blade is greater than or equal to 30 mm, and less than or equal to 70 mm, the hardness of the blade body is greater than or equal to 10 HRC, and less than or equal to 25 HRC.

For example, when the linear velocity of the blade is equal to 44 m/s-45 m/s, the effective length of the blade is equal to 15 mm, and the hardness of the blade body is 20-30 HRC. And when the linear velocity of the blade is equal to 49 m/s-50 m/s, the effective length of the blade is 30 mm or above, and the hardness of the blade body is 10-20 HRC. For example, in some embodiments, when the linear velocity of the blade is equal to 49 m/s-50 m/s, the effective length of the blade is 50 mm-60 mm, and the hardness of the blade body is 10-20 HRC. It should be pointed out that the effective length of the blade being 50 mm-60 mm is to cover the multi-layer blade, for example, the effective length of the bottommost layer blade is 50 mm, and the effective length of the topmost layer blade is 60 mm.

It should be pointed out that the overall length of the blade is equal to the sum of the effective length of the blade and the blade installation length. In some embodiments, the blade installation length is usually in the range of 10-15 mm. Therefore, the overall length of the blade is equal to the effective length of the blade plus (10-15) mm; wherein, the blade installation length refers to, for example, the length of the blade installed on the cutting disc or the length of the blade that cannot extend from the cutting disc.

Considering that the manufacturing difficulty is high when the blade thickness is extremely thick, therefore, the blade should not be extremely thick. In some embodiments, the blade thickness is less than or equal to 5 mm. Further, the blade thickness is less than or equal to 2 mm. Considering that the risk of blade breakage also increases when the blade thickness is extremely thin, therefore, the blade should not be extremely thin. In some embodiments, the blade thickness is greater than or equal to 0.5 mm. Further, the blade thickness is greater than or equal to 0.9 mm.

From the above, it can be known that the blade cannot be made extremely thin nor extremely thick. Therefore, in some embodiments, the blade thickness is greater than or equal to 0.5 mm, and less than or equal to 5 mm. Further, the blade thickness is greater than or equal to 0.5 mm, and less than or equal to 2 mm. In some embodiments, the blade thickness is greater than or equal to 0.9 mm, and less than or equal to 5 mm. Further, the blade thickness is greater than or equal to 0.9 mm, and less than or equal to 2 mm.

In summary, for example, the blade thickness may be selected as 0.6 mm, 0.9 mm, 1.2 mm, etc.

It should be noted that, in other embodiments, in order to reduce the risk of blade breakage, on the other hand, the difference between the hardness of the blade body and the hardness of the cutting portion may also be set to be relatively high, and the difference between the two is controlled within a certain range. In other words, the hardness of the blade body is set lower to meet the high toughness requirement of the base under a high linear velocity, and the hardness of the cutting portion is set higher to meet the high wear-resistance requirement of the lawn mowing operation under the high linear velocity. For example, when the linear velocity of the blade is greater than or equal to 30 m/s, the difference between the hardness of the blade body and the hardness of the cutting portion is controlled at 40-80 HRC; further, the difference between the hardness of the blade body and the hardness of the cutting portion is controlled at 50-80 HRC; wherein the hardness of the blade body is less than the hardness of the cutting portion. Such a setting method can prevent blade breakage when the blade is impacted by a hard object, especially at the connection between the blade body and the cutting portion.

In order to improve the cutting efficiency, the travel speed of the lawn mower usually needs to be increased. When the travel speed becomes higher, the grass volume per unit area increases. In order to cut the increased grass volume, the requirement for the cutting quality is correspondingly raised. Therefore, in order to meet to the cutting quality requirement when the travel speed becomes higher, in some embodiments, the kinetic energy of the blade may be increased. And an improvement of the blade kinetic energy may be achieved, for example, by increasing the blade rotation speed, the blade size, or the blade linear velocity, which leads to the probability of the blade breakage during a collision. However, the cutting quality requirement of the lawn mower where the linear velocity needs to be adaptively increased due to another factor (such as a larger blade size, the multi-layer blade) can also be adapted.

That is to say, when the travel speed increases, the risk of blade breakage usually increases. Therefore, how to reduce the blade breakage problem caused by the increased travel speed has become one of urgent issues to be solved for the lawn mower, especially for the large lawn mower in commercial scenario (such as riding lawn mowers).

The applicant found that while the travel speed increases, in order to reduce the risk of blade breakage, in a first aspect, the blade thickness may be increased, but considering that the manufacturing difficulty is high due to an excessively thick blade, the blade thickness should not be too thick.

It should be noted that the thicker the blade, the higher the blade body hardness can be, but existing processes cannot achieve an excessively large blade thickness.

In a second aspect, the effective length of the blade may be shortened, but considering that grass cannot be cut when the effective length of the blade is extremely short, the effective length of the blade should not be extremely short.

That is to say, the shorter the length of the blade extending from the cutting disc, the less likely the blade is to break, but when the length of the blade extending from the cutting disc is extremely short, grass cannot be cut, and the cutting quality decreases.

In a third aspect, the hardness of the blade may be addressed by improving the blade body. For example, making the blade body soft, that is, reducing the hardness of the blade body so that the blade body has better toughness; or simultaneously improving the hardness of the blade body and the hardness of the cutting portion, for example, reducing the hardness of the blade body and increasing the hardness of the cutting portion, so that the blade can meet both the toughness and the wear-resistance requirement.

It should be noted that, in other embodiments, the force of the cutting portion may also be released to the blade body by increasing the difference in hardness between the blade body and the cutting portion.

However, the applicant considered problems existing in solving the blade breakage through the first aspect and the second aspect, therefore, the applicant mainly addresses the blade breakage problem caused by the increased linear velocity through the third aspect.

That is to say, the present disclosure, given that when the travel speed increases, but the blade thickness cannot be extremely thick and the length of the blade extending from the cutting disc cannot be extremely short, reduces the risk of blade breakage by reducing the hardness of the blade body.

It should be noted that, in other embodiments, when the travel speed increases, the risk of blade breakage may also be reduced by increasing the difference in hardness between the blade body and the cutting portion.

The following provides a detailed description of the requirement for the blade body hardness and the requirement for the cutting portion hardness when the travel speed increases.

In some embodiments, when the travel speed of the blade is greater than or equal to a set value, wherein the set value is 0.8 m/s; on one hand, the hardness of the blade may be made softer by controlling the hardness of the blade body. For example, when the travel speed of the blade is greater than or equal to 1 m/s, the hardness of the blade body is controlled to be below 45 HRC; that is, the hardness of the blade body is less than or equal to 45 HRC. Further, when the travel speed of the blade is greater than or equal to 1 m/s, the hardness of the blade body is less than or equal to 30 HRC. Further, when the travel speed of the blade is greater than or equal to 1 m/s, the hardness of the blade body is less than or equal to 25 HRC. For another example, when the travel speed of the blade is greater than or equal to 1.5 m/s, the hardness of the blade body is controlled to be below 45 HRC; that is, the hardness of the blade body is less than or equal to 45 HRC. Further, when the travel speed of the blade is greater than or equal to 1.5 m/s, the hardness of the blade body is less than or equal to 30 HRC. Further, when the travel speed of the blade is greater than or equal to 1.5 m/s, the hardness of the blade body is less than or equal to 25 HRC.

Considering that the blade body is prone to bending when the hardness of the blade body is extremely low, therefore, the hardness of the blade body should not be extremely low. For example, in some embodiments, when the travel speed of the blade is greater than or equal to 1 m/s, the hardness of the blade body is greater than or equal to 5 HRC. Further, when the travel speed of the blade is greater than or equal to 1 m/s, the hardness of the blade body is greater than or equal to 10 HRC. For another example, in some embodiments, when the travel speed of the blade is greater than or equal to 1.5 m/s, the hardness of the blade body is greater than or equal to 5 HRC. Further, when the travel speed of the blade is greater than or equal to 1.5 m/s, the hardness of the blade body is greater than or equal to 10 HRC.

From the above, it can be known that, for example, in some embodiments, when the travel speed of the blade is greater than or equal to 1 m/s, the hardness of the blade body is greater than or equal to 5 HRC, and less than or equal to 45 HRC.

Further, when the travel speed of the blade is greater than or equal to 1 m/s, the hardness of the blade body is greater than or equal to 10 HRC, and less than or equal to 30 HRC. For example, when the travel speed of the blade is greater than or equal to 1.5 m/s, the hardness range of the blade body is 10-30 HRC.

Furthermore, when the travel speed of the blade is greater than or equal to 1 m/s, the hardness of the blade body is greater than or equal to 10 HRC, and less than or equal to 25 HRC. For example, when the travel speed of the blade is greater than or equal to 1.5 m/s, the hardness range of the blade body is 10-25 HRC.

For another example, in some embodiments, when the travel speed of the blade is greater than or equal to 1.5 m/s, the hardness of the blade body is greater than or equal to 5 HRC, and less than or equal to 45 HRC.

Further, when the travel speed of the blade is greater than or equal to 1.5 m/s, the hardness of the blade body is greater than or equal to 10 HRC, and less than or equal to 30 HRC. For example, when the travel speed of the blade is greater than or equal to 2 m/s, the hardness range of the blade body is 20-30 HRC.

Furthermore, when the travel speed of the blade is greater than or equal to 1.5 m/s, the hardness of the blade body is greater than or equal to 10 HRC, and less than or equal to 25 HRC. For example, when the travel speed of the blade is greater than or equal to 2 m/s, the hardness range of the blade body is 10-20 HRC.

Further, considering that the cutting portion is not wear-resistant if the hardness of the cutting portion is extremely low, and the cutting portion is limited by process materials if the hardness of the cutting portion is extremely high. In other words, the higher the hardness of the cutting portion, the more wear-resistant the cutting portion is, but current processes cannot achieve an extremely high hardness. In summary, in order to make the cutting portion meet the wear-resistance requirement, in some embodiments, the hardness of the cutting portion may be controlled to meet the wear-resistance requirement. For example, when the travel speed of the blade is greater than or equal to 1 m/s, the hardness of the cutting portion is greater than or equal to 50 HRC; further, when the travel speed of the blade is greater than or equal to 1 m/s, the hardness of the cutting portion is greater than or equal to 55 HRC. For example, when the travel speed of the blade is greater than or equal to 34 m/s, the hardness of the cutting portion is greater than or equal to 55 HRC. Furthermore, when the travel speed of the blade is greater than or equal to 1 m/s, the hardness of the cutting portion is greater than or equal to 60 HRC. For example, when the travel speed of the blade is greater than or equal to 40 m/s, the hardness of the cutting portion is greater than or equal to 60 HRC.

Considering the current process limitation, the hardness of the cutting portion cannot be made extremely high, in some embodiments, when the travel speed of the blade is greater than or equal to 1 m/s, the hardness of the cutting portion is less than or equal to 80 HRC. Further, when the travel speed of the blade is greater than or equal to 1 m/s, the hardness of the cutting portion is less than or equal to 75 HRC. For example, when the travel speed of the blade is greater than or equal to 34 m/s, the hardness of the cutting portion is less than or equal to 75 HRC. Furthermore, when the travel speed of the blade is greater than or equal to 1 m/s, the hardness of the cutting portion is less than or equal to 70 HRC. For example, when the travel speed of the blade is greater than or equal to 40 m/s, the hardness of the cutting portion is less than or equal to 70 HRC.

In summary, in some embodiments, when the travel speed of the blade is greater than or equal to 1 m/s, the hardness of the cutting portion is greater than or equal to 50 HRC, and less than or equal to 80 HRC. For example, when the travel speed of the blade is 1 m/s, the hardness of the blade body is 60-70 HRC.

In some embodiments, when the travel speed of the blade is greater than or equal to 1 m/s, the hardness of the cutting portion is greater than or equal to 55 HRC, and less than or equal to 75 HRC. For example, when the travel speed of the blade is greater than or equal to 1.5 m/s, the hardness of the cutting portion is 60-70 HRC.

In some embodiments, when the travel speed of the blade is greater than or equal to 1 m/s, the hardness of the cutting portion is greater than or equal to 60 HRC, and less than or equal to 70 HRC. For example, when the travel speed of the blade is equal to 1.5 m/s, the hardness of the cutting portion is 60-70 HRC. For another example, when the travel speed of the blade is equal to 2 m/s, the hardness of the cutting portion is 60-70 HRC.

In some embodiments, in order to meet the toughness requirement of the blade body and the wear-resistance requirement of the cutting portion, the hardness of the blade body and the hardness of the cutting portion may be controlled. For example, when the travel speed of the blade is greater than or equal to 1 m/s, the hardness of the blade body is 5-45 HRC, and the hardness of the cutting portion is 50 or above. For another example, when the travel speed of the blade is greater than or equal to 1 m/s, the hardness of the blade body is 10-30 HRC, and the hardness of the cutting portion is 55 or above. For another example, when the travel speed of the blade is greater than or equal to 1 m/s, the hardness of the blade body is 10-25 HRC, and the hardness of the cutting portion is 60 or above.

Considering current process limitations, the hardness of the cutting portion cannot be made extremely high. In some embodiments, for example, when the travel speed of the blade is greater than or equal to 1 m/s, the hardness of the blade body is 5-45 HRC, and the hardness of the cutting portion is 50-80 HRC. For another example, when the travel speed of the blade is greater than or equal to 1 m/s, the hardness of the blade body is 10-30 HRC, and the hardness of the cutting portion is 55-75 HRC. For another example, when the travel speed of the blade is greater than or equal to 1 m/s, the hardness of the blade body is 10-25 HRC, and the hardness of the cutting portion is 60-70 HRC.

In summary, in some embodiments, when the travel speed of the blade is greater than or equal to 1 m/s and less than or equal to 70 m/s, the hardness of the blade body is greater than or equal to 5 HRC and less than or equal to 45 HRC; and the hardness of the cutting portion is greater than or equal to 50 HRC and less than or equal to 80 HRC. For example, when the travel speed of the blade is 1 m/s, the hardness of the blade body is 40 HRC, and the hardness of the blade body is 60-70 HRC.

In some embodiments, when the travel speed of the blade is greater than or equal to 1 m/s, the hardness of the blade body is greater than or equal to 10 HRC and less than or equal to 30 HRC; and the hardness of the cutting portion is greater than or equal to 55 HRC and less than or equal to 75 HRC. For example, when the travel speed of the blade is equal to 1.5 m/s, the hardness of the blade body is 20-30 HRC; and the hardness of the cutting portion is 60-70 HRC. For another example, when the travel speed of the blade is greater than or equal to 2 m/s, the hardness of the blade body is 20-30 HRC; and the hardness of the cutting portion is 60-70 HRC. In some embodiments, when the travel speed of the blade is equal to 2 m/s, the hardness of the blade body is 20-30 HRC; and the hardness of the cutting portion is 60-70 HRC.

In some embodiments, when the travel speed of the blade is greater than or equal to 1 m/s, the hardness of the blade body is greater than or equal to 10 HRC and less than or equal to 25 HRC; and the hardness of the cutting portion is greater than or equal to 60 HRC and less than or equal to 70 HRC. For example, when the travel speed of the blade is greater than or equal to 2 m/s, the hardness of the blade body is 10-20 HRC; and the hardness of the cutting portion is 60-70 HRC. In some embodiments, when the travel speed of the blade is equal to 2 m/s, the hardness of the blade body is 10-20 HRC; and the hardness of the cutting portion is 60-70 HRC.

Considering that the blade is disposed on the cutting disc, the length of the blade extending from the cutting disc (referred to as the effective length of the blade) affects the mowing efficiency. In other words, in order to improve the mowing efficiency, the effective length of the blade may be increased, when the effective length of the blade is too short, grass cannot be cut, the mowing quality decreases or the mowing effect is poor. Therefore, the effective length of the blade cannot be extremely short, for example, in some embodiments, the effective length of the blade is greater than or equal to 5 mm. Considering that for the large-volume lawn mower, for example the commercial lawn mower, the cutting efficiency and the cutting quality requirement are high, therefore the effective length requirement of the blade is higher, therefore, in some embodiments, the effective length of the blade is greater than or equal to 30 mm.

Considering that the length of the blade extending from the cutting disc (referred to as the effective length of the blade) is prone to breakage when extremely long, the effective length of the blade cannot be extremely long. For example, in some embodiments, the effective length of the blade is less than or equal to 70 mm.

In summary, in some embodiments, the effective length of the blade is greater than or equal to 5 mm and less than or equal to 70 mm. Further, the effective length of the blade is greater than or equal to 30 mm and less than or equal to 70 mm.

Note that, in order to improve the mowing quality or the mowing effect, the multi-blade may be adopted, that is, an improvement of the mowing quality is achieved through multiple cutting. Therefore, in some embodiments, for the same blade effective length, the cutting quality of the lawn mower using the multi-blade is greater than the cutting quality of the lawn mower using a single blade. For example, the effective length of the blade is 5 or 6 mm, the number of blades is selected as 5-6 pieces, to improve the cutting quality.

Note that, considering that the blade is disposed on the cutting disc, and the linear velocity of the blade is also related to the effective length of the blade, that is to say, the effective length of the blade also affects the linear velocity. For example, for the same rotation speed, the longer the effective length of the blade, the greater the linear velocity of the blade. Therefore, in order to increase the linear velocity, an increase may also be achieved by increasing the effective length of the blade. Considering that the grass cannot be cut when the linear velocity is extremely low, which in turn affects the cutting efficiency. Therefore, the effective length of the blade should not be extremely short. In some embodiments, the effective length of the blade is greater than 5 mm. Considering that the linear velocity is extremely high, the blade is prone to breakage, the effective length of the blade should not be extremely long. In some embodiments, the effective length of the blade is less than or equal to 70 mm. Considering that for the large-volume lawn mower, the cutting efficiency and the cutting quality requirement are high, therefore the effective length requirement of the blade is higher, therefore, in some embodiments, the effective length of the blade is greater than or equal to 30 mm.

In summary, in some embodiments, the effective length of the blade is greater than or equal to 5 mm and less than or equal to 70 mm. Further, the effective length of the blade is greater than or equal to 30 mm and less than or equal to 70 mm.

And in order to adapt to the increased risk of blade breakage caused by a longer blade (for the lawn mower with high requirement for the cutting efficiency and the cutting quality). In some embodiments, the hardness of the blade body should be lower. For example, the hardness of the blade body when the effective length of the blade is equal to 30 mm is less than the hardness of the blade body when the effective length of the blade is equal to 5 mm. In other words, the longer the effective length of the blade, the smaller the hardness of the blade body.

For example, in some embodiments, when the effective length of the blade is greater than or equal to 5 mm and less than or equal to 70 mm, the hardness of the blade body is greater than or equal to 10 HRC and less than or equal to 30 HRC. And when the effective length of the blade is greater than or equal to 30 mm and less than or equal to 70 mm, the hardness of the blade body is greater than or equal to 10 HRC and less than or equal to 25 HRC.

Further considering the lawn mower with the higher cutting quality requirement, the effective length of the blade is relatively longer.

Therefore, in some embodiments, when the travel speed of the blade is greater than or equal to 1.5 m/s, and the effective length of the blade is greater than or equal to 5 mm and less than or equal to 70 mm, the hardness of the blade body is greater than or equal to 10 HRC and less than or equal to 30 HRC. And when the linear velocity of the blade is greater than or equal to 1.5 m/s, and the effective length of the blade is greater than or equal to 30 mm and less than or equal to 70 mm, the hardness of the blade body is greater than or equal to 10 HRC and less than or equal to 25 HRC.

For another example, when the travel speed of the blade is greater than or equal to 2 m/s, and the effective length of the blade is greater than or equal to 5 mm and less than or equal to 70 mm, the hardness of the blade body is greater than or equal to 10 HRC and less than or equal to 30 HRC; and when the linear velocity of the blade is greater than or equal to 2 m/s, and the effective length of the blade is greater than or equal to 30 mm and less than or equal to 70 mm, the hardness of the blade body is greater than or equal to 10 HRC and less than or equal to 25 HRC.

For example, when the travel speed of the blade is equal to 2 m/s, the effective length of the blade is equal to 15 mm, and the hardness of the blade body is 20-30 HRC. And when the linear velocity of the blade is equal to 2 m/s, the effective length of the blade is 30 mm or above, and the hardness of the blade body is 10-20 HRC. For example, in some embodiments, when the linear velocity of the blade is equal to 2 m/s, the effective length of the blade is 50 mm-60 mm, and the hardness of the blade body is 10-20 HRC. Note that the effective length of the blade being 50 mm-60 mm is to cover the multi-layer blade, for example, the effective length of the bottommost layer blade is 50 mm, and the effective length of the topmost layer blade is 60 mm.

Note that the overall length of the blade is equal to the sum of the effective length of the blade and the blade installation length. In some embodiments, the blade installation length is usually in the range of 10-15 mm. Therefore, the overall length of the blade is equal to the effective length of the blade plus (10-15) mm; and the blade installation length refers to, for example, the length of the blade installed on the cutting disc or the length of the blade that cannot extend from the cutting disc.

Considering that the manufacturing difficulty is high when the blade thickness is extremely thick, the blade should not be extremely thick. In some embodiments, the blade thickness is less than or equal to 5 mm. Further, the blade thickness is less than or equal to 2 mm. Considering that the risk of blade breakage also increases when the blade thickness is extremely thin, the blade should not be extremely thin. In some embodiments, the blade thickness is greater than or equal to 0.5 mm. Further, the blade thickness is greater than or equal to 0.9 mm.

From the above, the blade cannot be made extremely thin nor extremely thick. Therefore, in some embodiments, the blade thickness is greater than or equal to 0.5 mm and less than or equal to 5 mm. Further, the blade thickness is greater than or equal to 0.5 mm and less than or equal to 2 mm. In some embodiments, the blade thickness is greater than or equal to 0.9 mm and less than or equal to 5 mm. Further, the blade thickness is greater than or equal to 0.9 mm and less than or equal to 2 mm.

In summary, for example, the blade thickness may be selected as 0.6 mm, 0.9 mm, 1.2 mm, etc.

Considering that the linear velocity is related to the travel speed, the travel speed increases, the linear velocity improves, descriptions of the two and a point not described in some embodiments may all refer to the previous discussions, and are not described here.

The power tool such as the lawn mower, the blade used needs to satisfy that the blade body has high toughness while an edge portion also has good wear-resistance. In some embodiments, one solution to meet the above requirement is to set the blade body and the cutting portion to two hardness, that is, the hardness of the blade body is less than the hardness of the cutting portion. However, with increasingly high requirements form consumers for the lawn mower use, in order to meet the high cutting quality requirement, the linear velocity of the blade during cutting is increased when using the lawn mower. And while the linear velocity is increased, in order to meet the toughness requirement of the blade body and the wear-resistance requirement of the cutting portion, the difference between the hardness of the blade body and the hardness of the cutting portion is set to be relatively large. That is, the hardness of the blade body is set lower, to meet the high toughness requirement of the base at a high linear velocity, and the hardness of the cutting portion is set higher, to meet the high wear-resistance requirement of the mowing operation at the high linear velocity. To prevent a situation where the blade is prone to breakage when the blade receives an impact from a hard object, especially at a connection between the blade body and the cutting portion. Based on an above issue, the present disclosure provides a blade solution to solve the above problem, as detailed in following embodiments.

As shown in FIG. 1 to FIG. 4, an embodiment of the present disclosure provides a blade 1, comprising a blade body 11 for connecting with the cutting disc, and a cutting portion 12 connected with the blade body 11 for performing mowing operations. The hardness of the blade body 11 is less than the hardness of the cutting portion 12, and the blade body 11 comprises at least two regions with different hardness, the cutting portion 12 comprises at least two regions with different hardness.

The blade of the present disclosure, by setting the blade body 11 to have at least two regions with different hardness, and the cutting portion 12 to have at least two regions with different hardness, a region with a higher hardness able to release force to a region with a lower hardness when the blade 1 receives a relatively large impact force. This helps the blade 1 to timely transfer and eliminate the impact force received by the blade 1 inside the blade 1, and reduces the risk of blade breakage of the blade 1.

In some embodiments, the hardness of the cutting portion 12 may range in [55 HRC, 80 HRC], a setting of a high hardness cutting portion improves the wear-resistance of the blade 1, increases the service life of the blade 1, and makes the blade 1 used for a longer time before becoming dull. And HRC is the hardness unit ROCKWELL, that is, Rockwell hardness. And a setting of the hardness range of the cutting portion 12 of the present disclosure only needs to meet the wear-resistance usage requirement of the cutting portion 12. Generally, within a certain range, the higher the hardness, the stronger the wear-resistance of the cutting portion 12. And selecting the hardness of the cutting portion 12 in a range of 55-80 HRC not only meets the wear-resistance usage requirement of the cutting portion 12, but also avoids relatively high manufacturing difficulty of the cutting portion 12 due to an excessively high hardness, leading to a relatively high manufacturing and usage cost of the blade 1. Specifically, the hardness of the cutting portion 12 may be 55 HRC, 65 HRC, 75 HRC or 80 HRC, etc.

In some embodiments, the linear velocity of the blade 1 is greater than or equal to 35 m/s. The blade 1 of the present disclosure can meet high toughness and high wear-resistance requirements at the linear velocity intensity requirement, and simultaneously greatly improves the grass cutting efficiency of the blade 1. Specifically, the linear velocity of the blade 1 may be 35 m/s, 40 m/s or 45 m/s, etc.

In some embodiments, the hardness value range of the blade body 11 may be in [10 HRC-35 HRC], a low hardness blade body 11 has a relatively high toughness, improves the impact resistance performance of the blade 1, and makes the blade body 11 able to utilize the toughness of the blade body 11 to play a buffering role against an impact force received when the blade 1 hits a hard object such as a stone, and further effectively prevents the blade 1 from breaking. Specifically, the hardness of the blade body 11 may be 10 HRC, 15 HRC, 25 HRC or 35 HRC, etc.

Please simultaneously refer to FIG. 4, in an example embodiment, the blade body 11 comprises a first hardness region 112 and a second hardness region 113, the first hardness region 112 is located on the outer side of the blade body 11, the second hardness region 113 is located on the inner side of the blade body 11. And the hardness of the first hardness region 112 is higher than that of the second hardness region 113. And setting the blade body 11 as two hardness regions, the hardness of the first hardness region 112 is set relatively high, which is beneficial for the first hardness region 112 to cut the grass, and the hardness of the second hardness region 113 is set lower than the first hardness region 112, which is beneficial for the first hardness region 112 to transfer the impact force received when cutting the grass to the second hardness region 113, helps the first hardness region 112 release a force, and can effectively prevent the breakage of the blade 1.

In some embodiments, the area of the first hardness region 112 is smaller than the area of the second hardness region 113, setting the area with lower hardness region to be larger improves the force releasing effect of the harder region. In other embodiments, the area of the first hardness region 112 may also be set to be greater than or equal to the area of the second hardness region 113.

In other embodiments, the blade body 11 may also comprise one or more additional regions with different hardness besides the first hardness region 112 and the second hardness region 113. Within a certain range, the more hardness regions the blade body 11 is divided into, the better the force releasing effect against the impact force received by the blade 1. However, the more regions with different hardness the blade body 11 is divided into, the higher the manufacturing cost of the blade 1, and different usage environments have different requirements on the number of hardness region divisions of the blade 1, the number of the different hardness regions of the blade body 11 may be set according to the usage condition.

Please simultaneously refer to FIG. 4, in an example embodiment, the cutting portion 12 comprises a third hardness region 121 and a fourth hardness region 122, the third hardness region 121 is located on the outer side of the cutting portion 12, the fourth hardness region 122 is located on the inner side of the cutting portion 12, and the hardness of the third hardness region 121 is higher than the hardness of the fourth hardness region 122. Setting the hardness of the fourth hardness region 122 lower than the hardness of the third hardness region 121 is beneficial for the third hardness region 121 to transfer the impact force received by the third hardness region 121 to the fourth hardness region 122, helps the third hardness region 121 release the force, and can effectively prevent the blade 1 from breaking.

In some embodiments, the area of the third hardness region 121 is smaller than the area of the fourth hardness region 122, setting the area of the smaller hardness region to be larger improves the force releasing effect of the harder region. In other embodiments, the area of the third hardness region 121 may also be set to be greater than or equal to the area of the fourth hardness region 122.

In other embodiments, the cutting portion 12 may also comprise one or more additional regions with different hardness besides the third hardness region 121 and the fourth hardness region 122. Within a certain range, the more hardness regions the cutting portion 12 is divided into, the better the force releasing effect against the impact force received by the blade 1. And the more regions with different hardness the cutting portion 12 is divided into, the higher the manufacturing cost of the blade 1, and different usage environments have different requirements on the number of hardness region divisions of the blade 1, the number of the different hardness regions of the cutting portion 12 may be set according to the usage condition.

In some embodiments, the number of the different hardness regions of the blade body 11 is greater than that of the cutting portion 12. Generally, the area of the blade body 11 is larger than the area of the cutting portion 12, making the blade body 11 more convenient than the cutting portion 12 for dividing into more regions of different hardness. A setting of more different hardness regions on the blade body 11 makes the force releasing effect of the blade 1 better.

In other embodiments, the number of the different hardness regions of the blade body 11 may be equal to or less than that of the cutting portion 12.

Please refer to FIG. 5, It should be noted that the outer side and the inner side described in the present disclosure are based on the blade 1 as a whole, a setting direction towards the edge of the blade 1 is the outer side, and a setting direction towards the interior of the blade 1 is the inner side.

In some embodiments, the width value range of the cutting portion 12 is in [0.1 mm, 5 mm]. A setting of the width of the cutting portion 12 only needs to ensure the cutting requirement of the cutting portion 12, and ensure that the cutting portion 12 can be reliably connected with the blade body 11, so that the production cost of the blade 1 can be greatly reduced under the premise of ensuring the wear-resistance strength of the blade 1. Specifically, the width of the cutting portion may be taken as 0.1 mm, 1 mm, 2 mm or 5 mm, etc.

In some embodiments, the blade 1 is made of a single piece of plate material, by performing different degrees of hardening treatments such as laser quenching, edge carburizing or induction quenching on the blade body 11 and the cutting portion 12, the blade body 11 and the cutting portion 12 respectively having the different hardness regions, to meet the high toughness requirement of the blade body 11 and simultaneously meet the high wear-resistance usage requirement of the cutting portion 12.

In some embodiments, the blade 1 may be formed from a single piece of plate material subjected to an integral tempering treatment, which can densify the metal grains of the blade body 11 and improve the impact resistance of the blade body 11. The cutting portion is hardened by adopting laser quenching process on an edge, thereby obtaining the blade 1 with the hardness of the cutting portion higher than the blade body 11. However, in other embodiments, the laser quenching may also be replaced by other processes, such as edge carburizing, induction quenching, etc.

In other embodiments, the blade body 11 may be set as an integral structure with different hardness regions, the cutting portion 12 is set as a plurality of components having different hardness. The plurality of components of the cutting portion 12 with different hardness materials are fixedly connected and then connected to the blade body 11. The design is helpful for an interior of the blade 1 to perform a force release. In other embodiments, the blade body 11 may also be set as a plurality of components having different hardness, the cutting portion 12 is set as an integral structure with different hardness regions. The plurality of components of the blade body 11 with different hardness are fixedly connected and then connected to the cutting portion 12. The design is also helpful for the interior of the blade 1 to perform a force release.

In other embodiments, the different hardness regions of the blade body 11 are made of different materials, and the different hardness regions of the cutting portion 12 are also made of different materials. The blade body 11 and the cutting portion 12 may be directly formed as an integral structure during molding, forming a plurality of connected components with different hardness. Furthermore, the cutting portion 12 and the blade body 11 may also be separately formed, forming a plurality of components with different hardness, and then the plurality of components with different hardness are fixedly connected together. In some embodiments, the plurality of components with different hardness of the cutting portion 12 and the plurality of components with different hardness of the blade body 11 are separately formed, and then the above-mentioned plurality of components are fixedly connected together by a method such as welding.

It should be noted that the components with different hardness of the cutting portion are connected into an integral structure, the plurality of components with different hardness of the blade body are connected into an integral structure; finally, the cutting portion connected into the integral structure and the blade body connected into the integral structure are connected again. A method of an above connection may adopt the same method, for example, welding, adhesive connection, self-clinching fastener connection, etc., which is not described in detail in some embodiments. However, in other embodiments, the method of the above connection may also adopt different connection methods, in other words, the connection method of the components with different hardness of the cutting portion, the connection method of the plurality of components with different hardness of the blade body, and the connection method of the cutting portion connected into the integral structure and the blade body connected into the integral structure, at least two different connection methods exist among three connection methods. For example, when there are two connection methods, 1) the connection method of the components with different hardness of the cutting portion and the connection method of the plurality of components with different hardness of the blade body adopt the first connection method, and the connection method between the cutting portion and the blade body is different from the connection method of the components with different hardness of the cutting portion. That is to say, the connection method between the cutting portion and the blade body adopts the second connection method, which is different from the first connection method; 2) the connection method of the components with different hardness of the cutting portion, and the connection method of the cutting portion and the blade body adopt the first connection method, and the connection method of the plurality of components with different hardness of the blade body is different from the connection method of the components with different hardness of the cutting portion. That is to say, the connection method of the plurality of components with different hardness of the blade body adopts the second connection method, which is different from the first connection method; 3) the connection method of the components with different hardness of the cutting portion adopts the first connection method, and the connection method of the cutting portion and the blade body, and the connection method of the plurality of components with different hardness of the blade body adopt a connection method different from the connection method of the components with different hardness of the cutting portion. That is to say, the connection method of the plurality of components with different hardness of the blade body, and the connection method of the cutting portion and the blade body both adopt the second connection method, which is different from the first connection method. The above first connection method for example adopts welding, the second connection method for example adopts adhesive connection or self-clinching fastener connection; or, the first connection method for example adopts adhesive connection, the second connection method for example adopts welding or self-clinching fastener connection; or, the first connection method for example adopts self-clinching fastener connection, the second connection method for example adopts welding or adhesive connection.

When three connection methods exist, that is, the connection method of the components with different hardness of the cutting portion is different from the connection method of the plurality of components with different hardness of the blade body, the connection method of the plurality of components with different hardness of the blade body is different from the connection method between the cutting portion and the blade body, and the connection method between the cutting portion and the blade body is different from the connection method of the components with different hardness of the cutting portion. That is to say, the connection method of the components with different hardness of the cutting portion adopts the first connection method, the connection method of the plurality of components with different hardness of the blade body adopts the second connection method, the connection method between the cutting portion and the blade body adopts the third connection method, three connection methods are all different. For example, the first connection method for example adopts the welding, the second connection method adopts one of the adhesive connection and the self-clinching fastener connection, the third connection method adopts another one of the adhesive connection and the self-clinching fastener connection; for another example, the first connection method adopts the adhesive connection, the second connection method adopts one of the welding and the self-clinching fastener connection, the third connection method adopts another one of the welding and the self-clinching fastener connection; for another example, the first connection method adopts the self-clinching fastener connection, the second connection method adopts one of the welding and the adhesive connection, the third connection method adopts another one of the welding and the adhesive connection.

The connection between the cutting portion and the blade body adopts welding, and the connection of the components with different hardness of the cutting portion (and/or the blade body) adopts adhesive (or self-clinching fastener) connection.

The connection between the cutting portion and the blade body adopts welding, and the connection of the components with different hardness of the cutting portion (and/or the blade body) adopts adhesive (or self-clinching fastener) connection.

As shown in FIG. 5, in some embodiments, one end of the blade body 11 is provided with a rotating shaft installation hole 111 for mounting a rotating shaft 211. The hardness of the rotating shaft 211 is greater than the hardness of the blade body 11. This arrangement can reduce wear of the rotating shaft 211, and during long-term use, can reduce wear between the rotating shaft 211 and the blade body 11, and further reduce the frequency of changing the blade 1. Generally, since the cutting portion 12 wears greatly during the mowing operation, before the cutting portion 12 wears out and cannot work, a situation of replacing the blade 1 solely due to the wear between the rotating shaft 211 and the blade body 11 basically does not occur.

As shown in FIG. 1, in an embodiment, the blade 1 of the present disclosure further comprises a dulling zone 13 for gripping the blade body 11, the dulling zone 13 is disposed on the blade body 11 at the end close to the rotating shaft installation hole 111. The dulling zone 13 is not provided with an edge like the cutting portion 12, in order to facilitate an operator to hold the dulling zone 13 to perform replacement or maintenance of the blade 1.

As shown in FIG. 5, another embodiment of the present disclosure further provides the lawn mower 2, comprising a body 22, a cutting disc 21 and a blade assembly; and the cutting disc 21 is disposed on the body 22, the blade assembly is connected to the cutting disc 21 and follows the cutting disc 21 to rotate together to perform the mowing operation, the blade assembly comprises at least two blades 1 as in the above embodiments.

The lawn mower 2 in some embodiments, by setting the blade body 11 to have at least two regions with different hardness, and the cutting portion 12 to have at least two regions with different hardness, makes the force of the region with higher hardness able to release force to the region with lower hardness when the blade 1 receives a relatively large impact force, helps the blade 1 to timely transfer and eliminate the impact force received inside the blade 1, and reduces the risk of blade breakage of the blade 1.

As shown in FIG. 5, in an example embodiment, the blade 1 on the lawn mower 2 of the present disclosure is provided with a plurality, the plurality of blades 1 are disposed layer by layer from top to bottom on the cutting disc 21, showing a stepped distribution. That is, the diameter of the cutting trajectory of the blade 1 located above is greater than the diameter of the cutting trajectory located below. Due to the larger diameter, in the cutting process, the blade 1 located above will contact grass first to perform a cutting on the upper end of the grass; the blade 1 located in the middle of the cutting disc 21 subsequently performs the cutting on the grass; the blade 1 located below then performs a cutting on a part of the grass close to the ground, thereby ensuring that long grass is cut more broken.

And, under a circumstance of ensuring the grass can be cut broken enough, a certain distance is spaced between two adjacent blades 1, the distance is generally 10-20 mm, to prevent adjacent blades 1 from colliding with each other and causing a damage to the blade 1. In some examples, the number of blades 1 may be 3, 5, 6 or 8, etc.

Note that the above has described some embodiments of the present disclosure. Other embodiments are within the scope of the appended claims. In some cases, actions or steps described in the claims may be executed in an order different from the above embodiments and still can achieve a desired result. In addition, a process depicted in the drawings does not necessarily require the shown specific order or continuous order to achieve a desired result.

A person of ordinary skill in the art should understand: the discussion of any above embodiment is only exemplary, and is not intended to imply a scope of the present disclosure (including the claims) is limited to the examples; under an idea of the present disclosure, a technical feature in the above embodiments or different embodiments may also be combined, a step may be realized in an arbitrary order, and many other variations of different aspects of the embodiments of the present disclosure exist as described above, and the variations are not provided in detail for conciseness.

An embodiment of the present disclosure is intended to cover all such replacements, modifications and variations falling within a broad scope of the appended claims. Therefore, any omission, modification, equivalent replacement, improvement, etc. made within a spirit and a principle of the embodiments of the present disclosure shall be included in a protection scope of the present disclosure.

What is claimed is:

1. A lawn mower, wherein the lawn mower comprises:
a body;
a movement module configured to drive the lawn mower to move; and
a cutting disc comprising a blade, the cutting disc rotating under driving of a cutting motor to drive the blade to rotate, the blade comprising: a blade body for connecting with the cutting disc, and a cutting portion connected with the blade body for performing mowing operations;
wherein:
the movement module is configured to drive the lawn mower to move at a travel speed greater than or equal to 1 m/s, and
the cutting motor is configured to drive the blade to rotate to achieve a linear velocity of the blade greater than or equal to 30 m/s and less than or equal to 70 m/s, and
the blade body has a hardness value in a hardness value range of 5-45 HRC.

2. The lawn mower according to claim 1, wherein the travel speed is greater than or equal to 1.5 m/s.

3. The lawn mower according to claim 1, wherein the travel speed is greater than or equal to 2 m/s.

4. The lawn mower according to claim 1, wherein the linear velocity of the blade is greater than or equal to 40 m/s and less than or equal to 60 m/s, and the hardness value range is 10-30 HRC.

5. The lawn mower according to claim 1, wherein the travel speed is greater than or equal to 1.5 m/s, and the linear velocity of the blade is greater than or equal to 40 m/s and less than or equal to 60 m/s, and the hardness value range is 10-30 HRC.

6. The lawn mower according to claim 1, wherein the travel speed is greater than or equal to 2 m/s, and the linear velocity of the blade is greater than or equal to 40 m/s and less than or equal to 60 m/s, and the hardness value range is 10-30 HRC.

7. The lawn mower according to claim 1, wherein the linear velocity of the blade is greater than or equal to 40 m/s and less than or equal to 60 m/s, the hardness value range is 10-25 HRC.

8. The lawn mower according to claim 1, wherein the travel speed is greater than or equal to 1.5 m/s, and the linear velocity of the blade is greater than or equal to 40 m/s and less than or equal to 60 m/s, and the hardness value range is 10-25 HRC.

9. The lawn mower according to claim 1, wherein the travel speed is greater than or equal to 2 m/s, and the linear velocity of the blade is greater than or equal to 40 m/s and less than or equal to 60 m/s, and the hardness value range is 10-25 HRC.

10. The lawn mower according to claim 1, wherein a hardness of the cutting portion is greater than or equal to 50 HRC.

11. The lawn mower according to claim 1, wherein a hardness of the cutting portion is greater than or equal to 60 HRC.

12. The lawn mower according to claim 1, wherein a hardness of the cutting portion is less than or equal to 80 HRC.

13. The lawn mower according to claim 1, wherein a hardness range of the cutting portion is 60-70 HRC.

14. The lawn mower according to claim 1, wherein a length of the blade extending from the cutting disc is greater than or equal to 5 mm.

15. The lawn mower according to claim 1, wherein a length of the blade extending from the cutting disc is 5-70 mm.

16. The lawn mower according to claim 1, wherein a length of the blade extending from the cutting disc is 30-70 mm.

17. The lawn mower according to claim 1, wherein a thickness of the blade is less than or equal to 5 mm.

18. The lawn mower according to claim 1, wherein a thickness of the blade is 0.5-2 mm.

19. The lawn mower according to claim 1, wherein a width of the cutting portion is 0.1-5 mm.

20. The lawn mower according to claim 1, wherein the cutting disc further comprises 2-5 additional blades.
